(19) United States
(12) Patent Application Publication
(10) Pub. No.: US 2013/0052447 A1
(43) Pub. Date: Feb. 28, 2013

(54) Liquid Crystalline Polymer Composition Containing a Fibrous Filler

(71) Applicants: Joseph J. Grenci, Florence, KY (US); Kamlesh P. Nair, Florence, KY (US)

(72) Inventors: Joseph J. Grenci, Florence, KY (US); Kamlesh P. Nair, Florence, KY (US)

(73) Assignee: TICONA LLC, Florence, KY (US)

(21) Appl. No.: 13/594,920

(22) Filed: Aug. 27, 2012

Related U.S. Application Data
(60) Provisional application No. 61/528,383, filed on Aug. 29, 2011.
(60) Provisional application No. 61/528,398, filed on Aug. 29, 2011.
(60) Provisional application No. 61/664,811, filed on Jun. 27, 2012.
(60) Provisional application No. 61/664,850, filed on Jun. 27, 2012.
(60) Provisional application No. 61/664,937, filed on Jun. 27, 2012.

(51) Int. Cl. C08L 67/04; C08L 77/00; C08L 71/10; C08L 61/02; C08K 5/20; C08L 67/03

(52) U.S. Cl. 428/220; 524/227

(57) ABSTRACT

A polymer composition that contains a thermotropic liquid crystalline polymer, fibrous filler (e.g., glass fibers), and a flow aid is provided. The flow aid is in the form of an aromatic amide oligomer which, due to its unique nature and properties, has the ability to dramatically reduce melt viscosity with only a minimal degree of blending with the polymer. More particularly, the fibrous filler is supplied to an extruder in conjunction with the polymer and/or at a location downstream thereof so that the polymer is still in a solid or solid-like state when it initially contacts the filler. In this manner, the fibrous filler and polymer are allowed to mix together while the composition still has a relatively high melt viscosity, which helps to uniformly disperse the fibrous filler within the polymer matrix. After a certain period of time, the aromatic amide oligomer is then supplied to the extruder at a location downstream from the fibrous filler to reduce the melt viscosity of the composition.

### RELATED APPLICATIONS

The present application claims priority to U.S. provisional application Ser. Nos. 61/528,383 and 61/528,398, filed on Aug. 29, 2011, and 61/664,811, 61/664,850, and 61/664,937, filed on Jun. 27, 2012, which are incorporated herein in their entirety by reference thereto.

### BACKGROUND OF THE INVENTION

Electrical components often contain molded parts that are formed from a liquid crystalline, thermoplastic resin. Recent demands on the electronic industry have dictated a decreased size of such components to achieve the desired performance and space savings. Unfortunately, however, it is often difficult to adequately fill a mold cavity of a small dimension (e.g., width or thickness) with a liquid crystalline polymer. Even when filling is accomplished, the thermo-mechanical properties of the resulting part is sometimes poor. As such, a need exists for a liquid crystalline polymer composition that can readily fill mold cavities of a small dimension, and yet still attain good thermo-mechanical properties.

### SUMMARY OF THE INVENTION

In accordance with one embodiment of the present invention, a method for forming a polymer composition within an extruder is disclosed, the extruder containing at least one rotatable screw within a barrel. The method comprises supplying a thermotropic liquid crystalline polymer and a fibrous filler to the extruder; blending the polymer and the fibrous filler within the extruder; and thereafter, supplying a flow aid to the extruder at a location that is downstream from the polymer and the fibrous filler, wherein the flow aid includes an aromatic amide oligomer.

In accordance with another embodiment of the present invention, a molded part is disclosed that comprises a polymer composition. The polymer composition has a melt viscosity of from about 0.5 to about 80 Pa-s, determined in accordance with ISO Test No. 11443 at a temperature of 350° C. and at a shear rate of 1000 s⁻¹, and comprises from about 30 wt. % to about 95 wt. % of a thermotropic liquid crystalline polymer, from about 2 wt. % to about 40 wt. % of a fibrous filler, and from about 0.1 wt. % to about 10 wt. % of an aromatic amide oligomer. The molded part has a blister free temperature of about 250° C. or more.

Other features and aspects of the present invention are set forth in greater detail below.

### BRIEF DESCRIPTION OF THE FIGURES

A full and enabling disclosure of the present invention, including the best mode thereof to one skilled in the art, is set forth more particularly in the remainder of the specification, including reference to the accompanying figures, in which:

FIG. 1 is the Proton NMR characterization for N1,N4-diphenylterephthalamide (Compound A);

FIG. 2 is the Proton NMR characterization for N1,N4-diphenylisoterephthalamide (Compound B);

FIG. 3 is the Proton NMR characterization for N1,N4-bis(2,3,4,5,6-pentafluorophenyl)terephthalamide (Compound C);

FIG. 4 is the Proton NMR characterization for N1,N3-bis(4-benzamidophenyl)benzene-1,3-dicarboxamide (Compound F2);

FIG. 5 is the Proton NMR characterization for N3-phenyl-N1-[3-[[3-(phenylcarbamoyl)benzoyl]amino]phenyl]benzene-1,3-dicarboxamide (Compound G2);

FIG. 6 is the Proton NMR characterization for N1,N3,N5-triphenylbenzene-1,3,5-tricarboxamide (Compound J);

FIG. 7 is the Proton NMR characterization for N1,N3,N5-tris(4-benzamidophenyl)benzene-1,3,5-tricarboxamide (Compound K);

FIG. 8 is a schematic illustration of one embodiment of an extruder screw that may be used to form the polymer composition of the present invention;

FIG. 9 is an exploded perspective view of one embodiment of a fine pitch electrical connector that may be formed according to the present invention;

FIG. 10 is a front view of opposing walls of the fine pitch electrical connector of FIG. 9;

FIGS. 11-12 are respective front and rear perspective views of an electronic component that can employ an antenna structure formed in accordance with one embodiment of the present invention; and

FIGS. 13-14 are perspective and front views of a compact camera module (“CCM”) that may be formed in accordance with one embodiment of the present invention.

### DETAILED DESCRIPTION

### Definitions

It is to be understood that the terminology used herein is for the purpose of describing particular embodiments only and is not intended to limit the scope of the present invention.

“Alkyl” refers to monovalent saturated aliphatic hydrocarbyl groups having from 1 to 10 carbon atoms and, in some embodiments, from 1 to 6 carbon atoms. “C_{x-y} alkyl” refers to alkyl groups having from x to y carbon atoms. This term includes, by way of example, linear and branched hydrocarbyl groups such as methyl (CH₃), ethyl (CH₃CH₂), n-propyl (CH₃CH₂CH₂), isopropyl ((CH₃)₂CH), n-butyl (CH₃CH₂CH2CH₂), isobutyl ((CH₃)₂CHCH₂), sec-butyl ((CH₃)(CH₃CH₂)CH), t-butyl ((CH₃)₃C), n-pentyl (CH₃CH₂CH₂CH₂CH₂), and neopentyl ((CH₃)₃CCH₂).

“Alkenyl” refers to a linear or branched hydrocarbyl group having from 2 to 10 carbon atoms and in some embodiments from 2 to 6 carbon atoms or 2 to 4 carbon atoms and having at least 1 site of vinyl unsaturation (>C═C<). For example, (Cₓ-C_{y})alkenyl refers to alkenyl groups having from x to y carbon atoms and is meant to include for example, ethenyl, propenyl, 1,3-butadienyl, and so forth.

“Alkynyl” refers to refers to a linear or branched monovalent hydrocarbon radical containing at least one triple bond. The term “alkynyl” may also include those hydrocarbyl groups having other types of bonds, such as a double bond and a triple bond.

“Aryl” refers to an aromatic group of from 3 to 14 carbon atoms and no ring heteroatoms and having a single ring (e.g., phenyl) or multiple condensed (fused) rings (e.g., naphthyl or anthryl). For multiple ring systems, including fused, bridged, and spiro ring systems having aromatic and non-aromatic rings that have no ring heteroatoms, the term “Aryl” applies when the point of attachment is at an aromatic carbon atom (e.g., 5,6,7,8 tetrahydronaphthalene-2-yl is an aryl group as its point of attachment is at the 2-position of the aromatic phenyl ring).

“Cycloalkyl” refers to a saturated or partially saturated cyclic group of from 3 to 14 carbon atoms and no ring heteroatoms and having a single ring or multiple rings including fused, bridged, and spiro ring systems. For multiple ring systems having aromatic and non-aromatic rings that have no ring heteroatoms, the term “cycloalkyl” applies when the point of attachment is at a non-aromatic carbon atom (e.g. 5,6,7,8,-tetrahydronaphthalene-5-yl). The term “cycloalkyl” includes cycloalkenyl groups, such as adamantyl, cyclopropyl, cyclobutyl, cyclopentyl, cyclooctyl, and cyclohexenyl. The term “cycloalkenyl” is sometimes employed to refer to a partially saturated cycloalkyl ring having at least one site of >C═C<ring unsaturation.

“Halo” or “halogen” refers to fluoro, chloro, bromo, and iodo.

“Haloalkyl” refers to substitution of alkyl groups with 1 to 5 or in some embodiments 1 to 3 halo groups.

“Heteroaryl” refers to an aromatic group of from 1 to 14 carbon atoms and 1 to 6 heteroatoms selected from oxygen, nitrogen, and sulfur and includes single ring (e.g., imidazolyl) and multiple ring systems (e.g., benzimidazol-2-yl and benzimidazol-6-yl). For multiple ring systems, including fused, bridged, and spiro ring systems having aromatic and non-aromatic rings, the term “heteroaryl” applies if there is at least one ring heteroatom and the point of attachment is at an atom of an aromatic ring (e.g., 1,2,3,4-tetrahydroquinolin-6-yl and 5,6,7,8-tetrahydroquinolin-3-yl). In some embodiments, the nitrogen and/or the sulfur ring atom(s) of the heteroaryl group are optionally oxidized to provide for the N oxide (N→O), sulfinyl, or sulfonyl moieties. Examples of heteroaryl groups include, but are not limited to, pyridyl, furanyl, thienyl, thiazolyl, isothiazolyl, triazolyl, imidazolyl, imidazolinyl, isoxazolyl, pyrrolyl, pyrazolyl, pyridazinyl, pyrimidinyl, purinyl, phthalazyl, naphthylpryidyl, benzofuranyl, tetrahydrobenzofuranyl, isobenzofuranyl, benzothiazolyl, benzoisothiazolyl, benzotriazolyl, indolyl, isoindolyl, indolizinyl, dihydroindolyl, indazolyl, indolinyl, benzoxazolyl, quinolyl, isoquinolyl, quinolizyl, quianazolyl, quinoxalyl, tetrahydroquinolinyl, isoquinolyl, quinazolinonyl, benzimidazolyl, benzisoxazolyl, benzothienyl, benzopyridazinyl, pteridinyl, carbazolyl, carbolinyl, phenanthridinyl, acridinyl, phenanthrolinyl, phenazinyl, phenoxazinyl, phenothiazinyl, and phthalimidyl.

“Heterocyclic” or “heterocycle” or “heterocycloalkyl” or “heterocyclyl” refers to a saturated or partially saturated cyclic group having from 1 to 14 carbon atoms and from 1 to 6 heteroatoms selected from nitrogen, sulfur, or oxygen and includes single ring and multiple ring systems including fused, bridged, and spiro ring systems. For multiple ring systems having aromatic and/or non-aromatic rings, the terms “heterocyclic”, “heterocycle”, “heterocycloalkyl”, or “heterocyclyl” apply when there is at least one ring heteroatom and the point of attachment is at an atom of a non-aromatic ring (e.g., decahydroquinolin-6-yl). In some embodiments, the nitrogen and/or sulfur atom(s) of the heterocyclic group are optionally oxidized to provide for the N oxide, sulfinyl, sulfonyl moieties. Examples of heterocyclyl groups include, but are not limited to, azetidinyl, tetrahydropyranyl, piperidinyl, N-methylpiperidin-3-yl, piperazinyl, N-methylpyrrolidin-3-yl, 3-pyrrolidinyl, 2-pyrrolidon-1-yl, morpholinyl, thiomorpholinyl, imidazolidinyl, and pyrrolidinyl.

It should be understood that the aforementioned definitions encompass unsubstituted groups, as well as groups substituted with one or more other functional groups as is known in the art. For example, an alkynyl, aryl, heteroaryl, cycloalkyl, or heterocyclyl group may be substituted with from 1 to 8, in some embodiments from 1 to 5, in some embodiments from 1 to 3, and in some embodiments, from 1 to 2 substituents selected from alkyl, alkenyl, alkynyl, alkoxy, acyl, acylamino, acyloxy, amino, quaternary amino, amide, imino, amidino, aminocarbonylamino, amidinocarbonylamino, aminothiocarbonyl, aminocarbonylamino, aminothiocarbonylamino, aminocarbonyloxy, aminosulfonyl, aminosulfonyloxy, aminosulfonylamino, aryl, aryloxy, arylthio, azido, carboxyl, carboxyl ester, (carboxyl ester)amino, (carboxyl ester)oxy, cyano, cycloalkyl, cycloalkyloxy, cycloalkylthio, guanidino, halo, haloalkyl, haloalkoxy, hydroxy, hydroxyamino, alkoxyamino, hydrazino, heteroaryl, heteroaryloxy, heteroarylthio, heterocyclyl, heterocyclyloxy, heterocyclylthio, nitro, oxo, thione, phosphate, phosphonate, phosphinate, phosphonamidate, phosphorodiamidate, phosphoramidate monoester, cyclic phosphoramidate, cyclic phosphorodiamidate, phosphoramidate diester, sulfate, sulfonate, sulfonyl, substituted sulfonyl, sulfonyloxy, thioacyl, thiocyanate, thiol, alkylthio, etc., as well as combinations of such substituents.

“Liquid Crystalline Polymer” generally refers to a polymer that can possess a rod-like structure that allows it to exhibit liquid crystalline behavior in its molten state (e.g., thermotropic nematic state). The polymer may contain aromatic units (e.g., aromatic polyesters, aromatic polyesteramides, etc.) so that it is wholly aromatic (e.g., containing only aromatic units) or partially aromatic (e.g., containing aromatic units and other units, such as cycloaliphatic units). The polymer may also be fully crystalline or semi-crystalline in nature.

### DESCRIPTION

It is to be understood by one of ordinary skill in the art that the present discussion is a description of exemplary embodiments only, and is not intended as limiting the broader aspects of the present invention.

Generally speaking, the present invention is directed to a polymer composition that contains a thermotropic liquid crystalline polymer, fibrous filler (e.g., glass fibers), and a flow aid. The flow aid is in the form of an aromatic amide oligomer which, due to its unique nature and properties, has the ability to dramatically reduce melt viscosity with only a minimal degree of blending with the polymer. Consequently, the present inventors have discovered a method by which a low melt viscosity polymer composition can be formed, but still possess excellent thermo-mechanical properties that are typically only possible with higher viscosity materials. More particularly, the fibrous filler is supplied to an extruder in conjunction with the polymer and/or at a location downstream thereof so that the polymer is still in a solid or solid-like state when it initially contacts the filler. In this manner, the fibrous filler and polymer are allowed to mix together while the composition still has a relatively high melt viscosity, which helps to uniformly disperse the fibrous filler within the polymer matrix. After a certain period of time, the aromatic amide oligomer is then supplied to the extruder at a location downstream from the fibrous filler to reduce the melt viscosity of the composition.

Thus, as a result of the present invention, the combination of a low viscosity and good dispersion of the fibrous filler can be simultaneously achieved. The polymer composition may, for instance, have a melt viscosity of from about 0.5 to about 80 Pa-s, in some embodiments from about 1 to about 40 Pa-s, and in some embodiments, from about 2 to about 20 Pa-s, determined at a shear rate of 1000 seconds⁻¹, as determined in accordance with ISO Test No. 11443 (or ASTM Test No. 1238-70) at a temperature of 350° C. (or at a temperature of about 20° C. above the melting point of the polymer). Even at such low melt viscosity values, however, a molded part formed from the polymer composition may still possess a relatively high degree of heat resistance. For example, the molded part may possess a “blister free temperature” of about 250° C. or greater, in some embodiments about 260° C. or greater, in some embodiments from about 265° C. to about 320° C., and in some embodiments, from about 270° C. to about 300° C. As explained in more detail below, the “blister free temperature” is the maximum temperature at which a molded part does not exhibit blistering when placed in a heated silicone oil bath. Such blisters generally form when the vapor pressure of trapped moisture exceeds the strength of the part, thereby leading to delamination and surface defects. Without intending to be limited by theory, it is believed that a high blister free temperature can be achieved in the present invention due to the ability to uniformly disperse the fibrous filler within the polymer matrix before significantly lowering its melt viscosity, which results in a stronger part that is less likely to delaminate as the vapor pressure creates an exit point.

Various embodiments of the present invention will now be described in more detail.

### I. Polymer Composition

A. Liquid Crystalline Polymer

Thermotropic liquid crystalline polymers that are employed in the melt-extruded substrate may include, for instance, aromatic polyesters, aromatic poly(esteramides), aromatic poly(estercarbonates), aromatic polyamides, etc., and may likewise contain repeating units formed from one or more aromatic hydroxycarboxylic acids, aromatic dicarboxylic acids, aromatic diols, aromatic aminocarboxylic acids, aromatic amines, aromatic diamines, etc., as well as combinations thereof. The precursor monomers used to form such polymers may generally vary as is known in the art. For example, monomer repeating units may be derived from one or more aromatic hydroxycarboxylic acids, aromatic dicarboxylic acids, aromatic diols, aromatic aminocarboxylic acids, aromatic amines, aromatic diamines, etc., as well as combinations thereof.

Aromatic polyesters, for instance, may be obtained by polymerizing (1) two or more aromatic hydroxycarboxylic acids; (2) at least one aromatic hydroxycarboxylic acid, at least one aromatic dicarboxylic acid, and at least one aromatic diol; and/or (3) at least one aromatic dicarboxylic acid and at least one aromatic diol, as well as derivatives of any of the foregoing. Examples of suitable aromatic hydroxycarboxylic acids include, 4-hydroxybenzoic acid; 4-hydroxy-4′-biphenylcarboxylic acid; 2-hydroxy-6-naphthoic acid; 2-hydroxy-5-naphthoic acid; 3-hydroxy-2-naphthoic acid; 2-hydroxy-3-naphthoic acid; 4′-hydroxyphenyl-4-benzoic acid; 3′-hydroxyphenyl-4-benzoic acid; 4′-hydroxyphenyl-3-benzoic acid, etc., as well as alkyl, alkoxy, aryl and halogen substituents thereof. Examples of suitable aromatic dicarboxylic acids include terephthalic acid; isophthalic acid; 2,6-naphthalenedicarboxylic acid; diphenyl ether-4,4′-dicarboxylic acid; 1,6-naphthalenedicarboxylic acid; 2,7-naphthalenedicarboxylic acid; 4,4′-dicarboxybiphenyl; bis(4-carboxyphenyl)ether; bis(4-carboxyphenyl)butane; bis(4-carboxyphenyl)ethane; bis(3-carboxyphenyl)ether; bis(3-carboxyphenyl)ethane, etc., as well as alkyl, alkoxy, aryl and halogen substituents thereof. Examples of suitable aromatic diols include hydroquinone; resorcinol; 2,6-dihydroxynaphthalene; 2,7-dihydroxynaphthalene; 1,6-dihydroxynaphthalene; 4,4′-dihydroxybiphenyl; 3,3′-dihydroxybiphenyl; 3,4′-dihydroxybiphenyl; 4,4′-dihydroxybiphenyl ether; bis(4-hydroxyphenyl)ethane, etc., as well as alkyl, alkoxy, aryl and halogen substituents thereof. In one particular embodiment, the aromatic polyester contains monomer repeat units derived from 4-hydroxybenzoic acid and 2,6-hydroxynaphthoic acid. The synthesis aromatic polyesters may be described in more detail in U.S. Pat. Nos. 4,161,470; 4,473,682; 4,522,974; 4,375,530; 4,318,841; 4,256,624; 4,219,461; 4,083,829; 4,184,996; 4,279,803; 4,337,190; 4,355,134; 4,429,105; 4,393,191; 4,421,908; 4,434,262; and 5,541,240.

In one particular embodiment, for example, an aromatic polyester may be formed that contains monomer repeat units derived from 4-hydroxybenzoic acid and terephthalic acid (“TA”) and/or isophthalic acid (“IA”). The monomer units derived from 4-hydroxybenzoic acid (“HBA”) may constitute from about 40 mol. % to about 95 mol. %, in some embodiments from about 45 mol. % to about 90 mol. %, and in some embodiments, from about 50 mol. % to about 80 mol. % of the polymer, while the monomer units derived from terephthalic acid and/or isophthalic acid may each constitute from about 1 mol. % to about 30 mol. %, in some embodiments from about 2 mol. % to about 25 mol. %, and in some embodiments, from about 3 mol. % to about 20 mol. % of the polymer. Other monomeric units may optionally be employed, such as aromatic diols (e.g., 4,4′-biphenol, hydroquinone, etc.) and/or hydroxycarboxylic acids (e.g., 6-hydroxy-2-naphthoic acid). For example, monomer units derived from hydroquinone (“HQ”), 4,4′-biphenol (“BP”), and/or acetaminophen (“APAP”) may each constitute from about 1 mol. % to about 30 mol. %, in some embodiments from about 2 mol. % to about 25 mol. %, and in some embodiments, from about 3 mol. % to about 20 mol. % when employed. If desired, the polymer may also contain monomer units derived from 6-hydroxy-2-naphthoic acid (“HNA”) in an amount of from about 1 mol. % to about 30 mol. %, in some embodiments from about 2 mol. % to about 25 mol. %, and in some embodiments, from about 3 mol. % to about 20 mol. % of the polymer.

Liquid crystalline polyesteramides may likewise be obtained by polymerizing (1) at least one aromatic hydroxycarboxylic acid and at least one aromatic aminocarboxylic acid; (2) at least one aromatic hydroxycarboxylic acid, at least one aromatic dicarboxylic acid, and at least one aromatic amine and/or diamine optionally having phenolic hydroxy groups; and (3) at least one aromatic dicarboxylic acid and at least one aromatic amine and/or diamine optionally having phenolic hydroxy groups, as well as derivatives of any of the foregoing. Suitable aromatic amines and diamines may include, for instance, 3-aminophenol; 4-aminophenol; 1,4-phenylenediamine; 1,3-phenylenediamine, etc., as well as alkyl, alkoxy, aryl and halogen substituents thereof. In one particular embodiment, the aromatic polyesteramide may contain monomer units derived from 2,6-hydroxynaphthoic acid, terephthalic acid, and 4-aminophenol. The monomer units derived from 2,6-hydroxynaphthoic acid may constitute from about 35% to about 85% of the polymer on a mole basis (e.g., 60%), the monomer units derived from terephthalic acid may constitute from about 5% to about 50% (e.g., 20%) of the polymer on a mole basis, and the monomer units derived from 4-aminophenol may constitute from about 5% to about 50% (e.g., 20%) of the polymer on a mole basis. Such aromatic polyesters are commercially available from Ticona, LLC under the trade designation VECTRA® B. In another embodiment, the aromatic polyesteramide contains monomer units derived from 2,6-hydroxynaphthoic acid, and 4-hydroxybenzoic acid, and 4-aminophenol, as well as other optional monomers (e.g., 4,4′-dihydroxybiphenyl and/or terephthalic acid). The synthesis and structure of these and other aromatic poly(esteramides) may be described in more detail in U.S. Pat. Nos. 4,339,375; 4,355,132; 4,351,917; 4,330,457; 4,351,918; and 5,204,443.

Regardless of the particular constituents, the liquid crystalline polymer may be prepared by introducing the appropriate monomer(s) (e.g., aromatic hydroxycarboxylic acid, aromatic dicarboxylic acid, aromatic diol, aromatic amine, aromatic diamine, etc.) into a reactor vessel to initiate a polycondensation reaction. The particular conditions and steps employed in such reactions are well known, and may be described in more detail in U.S. Pat. No. 4,161,470 to Calundann; U.S. Pat. No. 5,616,680 to Linstid, III, et al.; U.S. Pat. No. 6,114,492 to Linstid, III, et al.; U.S. Pat. No. 6,514,611 to Shepherd, et al.; and WO 2004/058851 to Waggoner. The vessel employed for the reaction is not especially limited, although it is typically desired to employ one that is commonly used in reactions of high viscosity fluids. Examples of such a reaction vessel may include a stirring tank-type apparatus that has an agitator with a variably-shaped stirring blade, such as an anchor type, multistage type, spiral-ribbon type, screw shaft type, etc., or a modified shape thereof. Further examples of such a reaction vessel may include a mixing apparatus commonly used in resin kneading, such as a kneader, a roll mill, a Banbury mixer, etc.

If desired, the reaction may proceed through the acetylation of the monomers as known in art. Acetylation may occur in a separate reactor vessel, or it may occur in situ within the polymerization reactor vessel. When separate reactor vessels are employed, one or more of the monomers may be introduced to the acetylation reactor and subsequently transferred to the melt polymerization reactor. Likewise, one or more of the monomers may also be directly introduced to the reactor vessel without undergoing pre-acetylation. Acetylation may be accomplished by adding an acetylating agent (e.g., acetic anhydride) to one or more of the monomers. One particularly suitable technique for acetylating monomers may include, for instance, charging precursor monomers (e.g., 4-hydroxybenzoic acid and 2,6-hydroxynaphthoic acid) and acetic anhydride into a reactor and heating the mixture to acetylize a hydroxyl group of the monomers (e.g., forming acetoxy).

Acetylation is generally initiated at temperatures of about 90° C. During the initial stage of the acetylation, reflux may be employed to maintain vapor phase temperature below the point at which acetic acid byproduct and anhydride begin to distill. Temperatures during acetylation typically range from between 90° C. to 150° C., and in some embodiments, from about 110° C. to about 150° C. If reflux is used, the vapor phase temperature typically exceeds the boiling point of acetic acid, but remains low enough to retain residual acetic anhydride. For example, acetic anhydride vaporizes at temperatures of about 140° C. Thus, providing the reactor with a vapor phase reflux at a temperature of from about 110° C. to about 130° C. is particularly desirable. To ensure substantially complete reaction, an excess amount of acetic anhydride may be employed. The amount of excess anhydride will vary depending upon the particular acetylation conditions employed, including the presence or absence of reflux. The use of an excess of from about 1 to about 10 mole percent of acetic anhydride, based on the total moles of reactant hydroxyl groups present is not uncommon. After any optional acetylation is complete, the resulting composition may be melt-polymerized. Although not required, this is typically accomplished by transferring the acetylated monomer(s) to a separator reactor vessel for conducting a polycondensation reaction. If desired, one or more of the precursor monomers used to form the liquid crystalline polymer may be directly introduced to the melt polymerization reactor vessel without undergoing pre-acetylation. Other components may also be included within the reaction mixture to help facilitate polymerization. For instance, a catalyst may be optionally employed, such as metal salt catalysts (e.g., magnesium acetate, tin(I)acetate, tetrabutyl titanate, lead acetate, sodium acetate, potassium acetate, etc.) and organic compound catalysts (e.g., N-methylimidazole). Such catalysts are typically used in amounts of from about 50 to about 500 parts per million based on the total weight of the recurring unit precursors. The catalyst is typically added to the acetylation reactor rather than the polymerization reactor, although this is by no means a requirement.

After melt-polymerization, the resulting polymer may be removed. In some embodiments, the polymer may also be subjected to a subsequent solid-state polymerization method to further increase its molecular weight. For instance, solid-state polymerization may be conducted in the presence of a gas (e.g., air, inert gas, etc.). Suitable inert gases may include, for instance, include nitrogen, helium, argon, neon, krypton, xenon, etc., as well as combinations thereof. The solid-state polymerization reactor vessel can be of virtually any design that will allow the polymer to be maintained at the desired solid-state polymerization temperature for the desired residence time. Examples of such vessels can be those that have a fixed bed, static bed, moving bed, fluidized bed, etc. The temperature at which solid-state polymerization is performed may vary, but is typically within a range of about 200° C. to about 350° C., in some embodiments from about 225° C. to about 325° C., and in some embodiments, from about 250° C. to about 300° C. The polymerization time will of course vary based on the temperature and target molecular weight. In most cases, however, the solid-state polymerization time will be from about 2 to about 12 hours, and in some embodiments, from about 4 to about 10 hours.

Regardless of the particular manner in which it is formed, the resulting liquid crystalline polymer will generally have a high number average molecular weight (Mₙ), such as about 2,000 grams per mole or more, in some embodiments from about 4,000 grams per mole or more, and in some embodiments, from about 5,000 to about 30,000 grams per mole. Of course, it is also possible to form polymers having a lower molecular weight, such as less than about 2,000 grams per mole, using the method of the present invention. The intrinsic viscosity of the polymer, which is generally proportional to molecular weight, may also be relatively high. For example, the intrinsic viscosity may be about 4 deciliters per gram (“dL/g”) or more, in some embodiments about 5 dL/g or more, in some embodiments from about 6 to about 20 dL/g, and in some embodiments from about 7 to about 15 dL/g. Intrinsic viscosity may be determined in accordance with ISO-1628-5 using a 50/50 (v/v) mixture of pentafluorophenol and hexafluoroisopropanol, as described in more detail below.

The melting temperature of the polymer may also range from about 250° C. to about 400° C., in some embodiments from about 270° C. to about 380° C., and in some embodiments, from about 300° C. to about 360° C. Likewise, the crystallization temperature may range from about 200° C. to about 400° C., in some embodiments from about 250° C. to about 350° C., and in some embodiments, from about 280° C. to about 320° C. The melting and crystallization temperatures may be determined as is well known in the art using differential scanning calorimetry (“DSC”), such as determined by ISO Test No. 11357.

B. Aromatic Amide Oligomer

As indicated above, an aromatic amide oligomer is also employed in the polymer composition of the present invention. Such an oligomer can serve as a “flow aid” by altering intermolecular polymer chain interactions, thereby lowering the overall viscosity of the polymer matrix under shear. However, the aromatic amide oligomer does not generally react with the polymer backbone of the liquid crystalline polymer to any appreciable extent. Another benefit of the oligomer is that it is not easily volatized or decomposed. This allows the oligomer to be added to the reaction mixture while it is still at relatively high temperatures. Without intending to be limited by theory, it is believed that active hydrogen atoms of the amide functional groups are capable of forming a hydrogen bond with the backbone of liquid crystalline polyesters or polyesteramides. Such hydrogen bonding strengthens the attachment of the oligomer to the liquid crystalline polymer and thus minimizes the likelihood that it becomes volatilized.

The aromatic amide oligomer generally has a relatively low molecular weight so that it can effectively serve as a flow aid for the polymer composition. For example, the oligomer typically has a molecular weight of about 3,000 grams per mole or less, in some embodiments from about 50 to about 2,000 grams per mole, in some embodiments from about 100 to about 1,500 grams per mole, and in some embodiments, from about 200 to about 1,200 grams per mole. In addition to possessing a relatively low molecular weight, the oligomer also generally possesses high amide functionality so it is capable of undergoing a sufficient degree of hydrogen bonding with the liquid crystalline polymer. The degree of amide functionality for a given molecule may be characterized by its “amide equivalent weight”, which reflects the amount of a compound that contains one molecule of an amide functional group and may be calculated by dividing the molecular weight of the compound by the number of amide groups in the molecule. For example, the aromatic amide oligomer may contain from 1 to 15, in some embodiments from 2 to 10, and in some embodiments, from 2 to 8 amide functional groups per molecule. The amide equivalent weight may likewise be from about 10 to about 1,000 grams per mole or less, in some embodiments from about 50 to about 500 grams per mole, and in some embodiments, from about 100 to about 300 grams per mole.

As indicated above, it is desirable that the aromatic amide oligomer is also generally unreactive so that it does not form covalent bonds with the liquid crystalline polymer backbone. To help better minimize reactivity, the oligomer typically contains a core formed from one or more aromatic rings (including heteroaromatic). The oligomer may also contain terminal groups formed from one or more aromatic rings. Such an “aromatic” oligomer thus possesses little, if any, reactivity with the base liquid crystalline polymer. For example, one embodiment of such an aromatic amide oligomer is provided below in Formula (I):

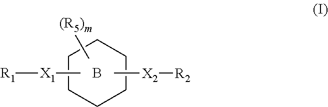

wherein,

ring B is a 6-membered aromatic ring wherein 1 to 3 ring carbon atoms are optionally replaced by nitrogen or oxygen, wherein each nitrogen is optionally oxidized, and wherein ring B may be optionally fused or linked to a 5- or 6-membered aryl, heteroaryl, cycloalkyl, or heterocyclyl;

R₅ is halo, haloalkyl, alkyl, alkenyl, aryl, heteroaryl, cycloalkyl, or heterocyclyl;

m is from 0 to 4;

X₁ and X₂ are independently C(O)HN or NHC(O); and

R₁ and R₂ are independently selected from aryl, heteroaryl, cycloalkyl, and heterocyclyl.

In certain embodiments, Ring B may be selected from the following:

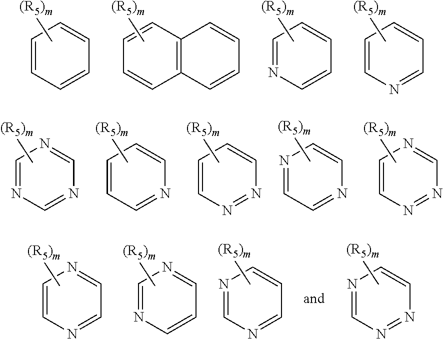

wherein,

m is 0, 1, 2, 3, or 4, in some embodiments m is 0, 1, or 2, in some embodiments m is 0 or 1, and in some embodiments, m is 0; and

R₅ is halo, haloalkyl, alkyl, alkenyl, aryl, heteroaryl, cycloalkyl, or heterocyclyl. Ring B may particularly be phenyl.

In certain embodiments, the oligomer is a di-functional compound in that Ring B is directly bonded to only two (2) amide groups (e.g., C(O)HN or NHC(O)). In such embodiments, m in Formula (I) may be 0. Of course, in certain embodiments, Ring B may also be directly bonded to three (3) or more amide groups. For example, one embodiment of such a compound is provided by general formula (II):

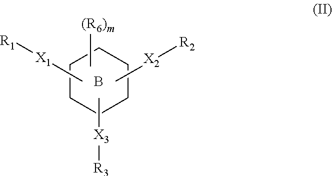

wherein,

ring B, R₅, X₁, X₂, R₁, and R₂ are as defined above;

m is from 0 to 3;

X₃ is C(O)HN or NHC(O); and

R₃ is selected from aryl, heteroaryl, cycloalkyl, and heterocyclyl.

Another embodiment of such a compound is provided by general formula (III):

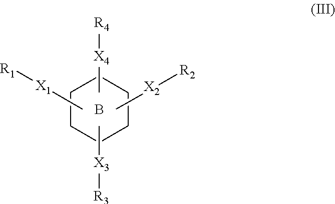

wherein,

ring B, R₅, X₁, X₂, X₃, R₁, R₂, and R₃ are as defined above;

X₄ is C(O)HN or NHC(O); and

R₄ is selected from aryl, heteroaryl, cycloalkyl, and heterocyclyl.

In some embodiments, R₁, R₂, R₃, and/or R₄ in the structures noted above may be selected from the following:

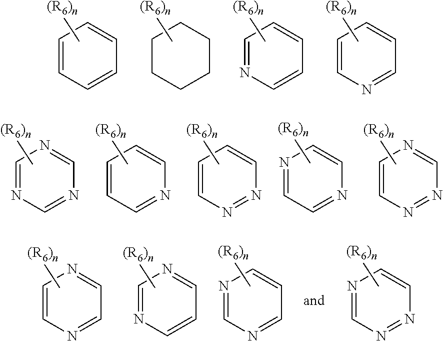

wherein,

n is 0, 1, 2, 3, 4, or 5, in some embodiments n is 0, 1, or 2, and in some embodiments, n is 0 or 1; and

R₆ is halo, haloalkyl, alkyl, alkenyl, aryl, heteroaryl, cycloalkyl, or heterocyclyl.

In one embodiment, the aromatic amide oligomer has the following general formula (IV):

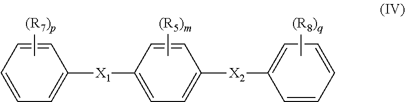

wherein,

X₁ and X₂ are independently C(O)HN or NHC(O);

R₅, R₇, and R₈ are independently selected from halo, haloalkyl, alkyl, alkenyl, aryl, heteroaryl, cycloalkyl, and heterocyclyl;

m is from 0 to 4; and

p and q are independently from 0 to 5.

In another embodiment, the aromatic amide oligomer has the following general formula (V):

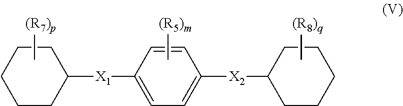

wherein,

X₁, X₂, R₅, R₇, R₈, m, p, and q are as defined above. For example, in certain embodiments, m, p, and q in Formula (IV) and Formula (V) may be equal to 0 so that the core and terminal groups are unsubstituted. In other embodiments, m may be 0 and p and q may be from 1 to 5. In such embodiments, for example, R₇ and/or R₈ may be halo (e.g., fluorine). In other embodiments, R₇ and/or R₈ may be aryl (e.g., phenyl), cycloalkyl (e.g., cyclohexyl), or aryl and/or cycloalkyl substituted with an amide group having the structure: —C(O)R₁₂N— or —NR₁₃C(O)—, wherein R₁₂ and R₁₃ are independently selected from hydrogen, alkyl, alkenyl, aryl, heteroaryl, cycloalkyl, and heterocyclyl. In one particular embodiment, for example, R₇ and/or R₈ are phenyl substituted with —C(O)HN— or —NHC(O)—. In yet other embodiments, R₇ and/or R₈ may be heteroaryl (e.g., pyridinyl).

In yet another embodiment, the aromatic amide oligomer has the following general formula (VI):

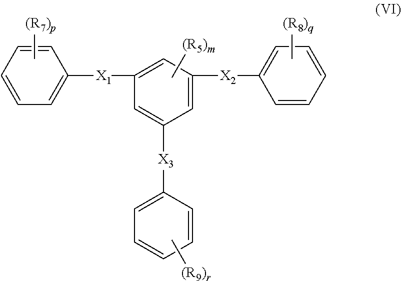

wherein,

X₁, X₂, and X₃ are independently C(O)HN or NHC(O);

R₅, R₇, R₈, and R₉ are independently selected from halo, haloalkyl, alkyl, alkenyl, aryl, heteroaryl, cycloalkyl, and heterocyclyl;

m is from 0 to 3; and

p, q, and r are independently from 0 to 5.

In yet another embodiment, the aromatic amide oligomer has the following general formula (VII):

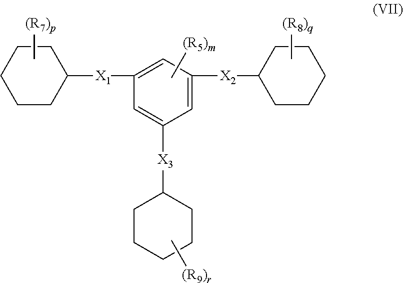

wherein,

X₁, X₂, X₃, R₅, R₇, R₈, R₉, m, p, q, and r are as defined above.

For example, in certain embodiments, m, p, q, and r in Formula (VI) or in Formula (VII) may be equal to 0 so that the core and terminal aromatic groups are unsubstituted. In other embodiments, m may be 0 and p, q, and r may be from 1 to 5. In such embodiments, for example, R₇, R₈, and/or R₉ may be halo (e.g., fluorine). In other embodiments, R₇, R₈, and/or R₉ may be aryl (e.g., phenyl), cycloalkyl (e.g., cyclohexyl), or aryl and/or cycloalkyl substituted with an amide group having the structure: —C(O)R₁₂N— or —NR₁₃C(O)—, wherein R₁₂ and R₁₃ are independently selected from hydrogen, alkyl, alkenyl, aryl, heteroaryl, cycloalkyl, and heterocyclyl. In one particular embodiment, for example, R₇, Ra, and/or R₉ are phenyl substituted with —C(O)HN— or —NHC(O)—. In yet other embodiments, R₇, R₈, and/or R₉ may be heteroaryl (e.g., pyridinyl).

Specific embodiments of the aromatic amide oligomer of the present invention are also set forth in the table below:

| Cmpd | | |
|---|---|---|
| # | Structure | Name |
| A | 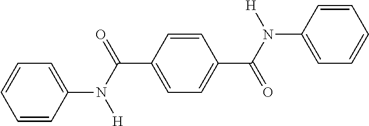 [SMILES: O=C(Nc1ccccc1)c1ccc(C(=O)Nc2ccccc2)cc1] | N1,N4- diphenylterephthalamide |
| B | 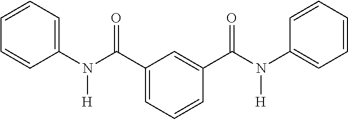 [SMILES: O=C(Nc1ccccc1)c1cccc(C(=O)Nc2ccccc2)c1] | N1,N4- diphenylisoterephthalamide |
| C | 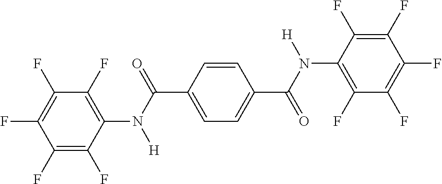 [SMILES: O=C(Nc1c(F)c(F)c(F)c(F)c1F)c1ccc(C(=O)Nc2c(F)c(F)c(F)c(F)c2F)cc1] | N1,N4-bis(2,3,4,5,6- pentafluorophenyl) terephthalamide |
| D | 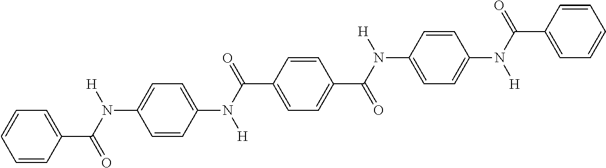 [SMILES: O=C(Nc1ccc(NC(=O)c2ccc(C(=O)Nc3ccc(NC(=O)c4ccccc4)cc3)cc2)cc1)c1ccccc1] | N1,N4-bis-(4- benzamidophenyl) terephthalamide |
| E | 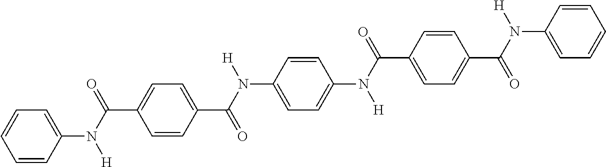 [SMILES: O=C(Nc1ccccc1)c1ccc(C(=O)Nc2ccc(NC(=O)c3ccc(C(=O)Nc4ccccc4)cc3)cc2)cc1] | N4-phenyl-N1[4-[[4- (phenylcarbamoyl)benzoyl] amino]phenyl] terephthalamide |
| F1 | 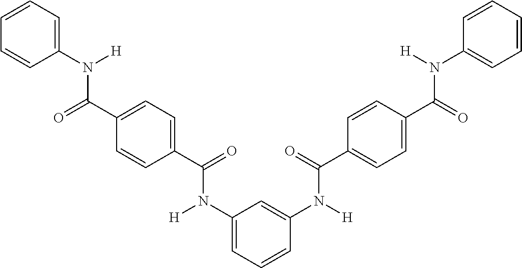 [SMILES: O=C(Nc1ccccc1)c1ccc(C(=O)Nc2cccc(NC(=O)c3ccc(C(=O)Nc4ccccc4)cc3)c2)cc1] | N4-phenyl-N1[3-[[4- (phenylcarbamoyl)benzoyl] amino]phenyl] terephthalamide |
| F2 | 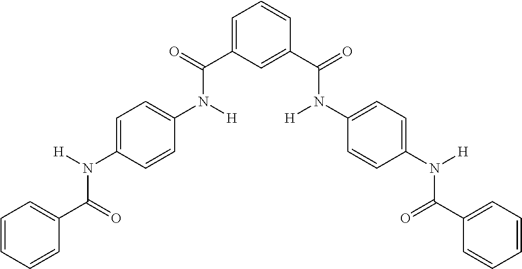 [SMILES: O=C(Nc1ccc(NC(=O)c2cccc(C(=O)Nc3ccc(NC(=O)c4ccccc4)cc3)c2)cc1)c1ccccc1] | N1,N3-bis(4- benzamidophenyl)benzene- 1,3-dicarboxamide |
| G1 | 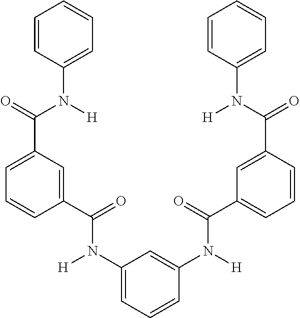 [SMILES: O=C(Nc1ccccc1)c1cccc(C(=O)Nc2cccc(NC(=O)c3cccc(C(=O)Nc4ccccc4)c3)c2)c1] | N3-phenyl-N1[3-[[3- (phenylcarbamoyl)benzoyl] amino]phenyl]benzene- 1,3-dicarboxamide |
| G2 | 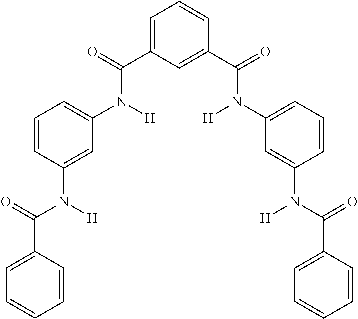 [SMILES: O=C(Nc1cccc(NC(=O)c2cccc(C(=O)Nc3cccc(NC(=O)c4ccccc4)c3)c2)c1)c1ccccc1] | N1,N3-bis(3- benzamidophenyl)benzene- 1,3-dicarboxamide |
| H | 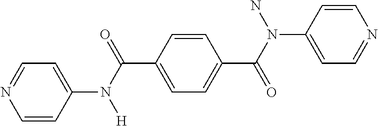 [SMILES: NN(C(=O)c1ccc(C(=O)Nc2ccncc2)cc1)c1ccncc1] | N1,N4-bis(4- pyridyl)terephthalamide |
| I | 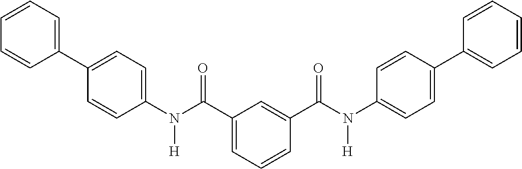 [SMILES: O=C(Nc1ccc(-c2ccccc2)cc1)c1cccc(C(=O)Nc2ccc(-c3ccccc3)cc2)c1] | N1,N3-bis(4- phenylphenyl)benzene-1,3- dicarboxamide |
| J | 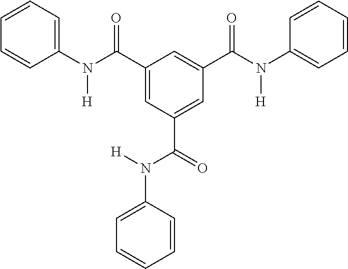 [SMILES: O=C(Nc1ccccc1)c1cc(C(=O)Nc2ccccc2)cc(C(=O)Nc2ccccc2)c1] | N1,N3,N5- triphenylbenzene-1,3,5- tricarboxamide |
| K | 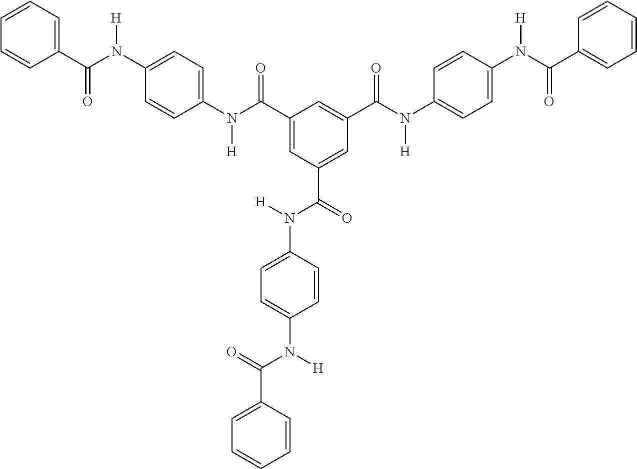 [SMILES: O=C(Nc1ccc(NC(=O)c2cc(C(=O)Nc3ccc(NC(=O)c4ccccc4)cc3)cc(C(=O)Nc3ccc(NC(=O)c4ccccc4)cc3)c2)cc1)c1ccccc1] | N1,N3,N5-tris(4- benzamidophenyl) benzene-1,3,5- tricarboxamide |
| L | 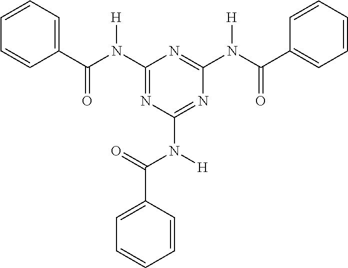 [SMILES: O=C(Nc1nc(NC(=O)c2ccccc2)nc(NC(=O)c2ccccc2)n1)c1ccccc1] | N-(4,6-dibenzamido-1,3,5- triazin-2-yl)benzamide |
| M1 | 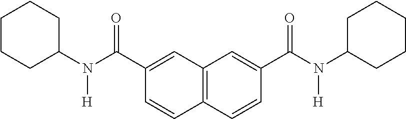 [SMILES: O=C(NC1CCCCC1)c1ccc2ccc(C(=O)NC3CCCCC3)cc2c1] | N2,N7- dicyclohexylnaphthalene- 2,7-dicarboxamide |
| M2 | 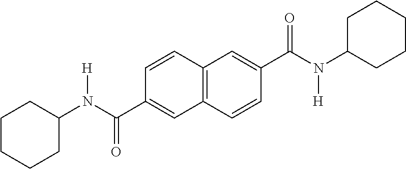 [SMILES: O=C(NC1CCCCC1)c1ccc2cc(C(=O)NC3CCCCC3)ccc2c1] | N2,N6- dicyclohexylnaphthalene- 2,6-dicarboxamide |
| N | 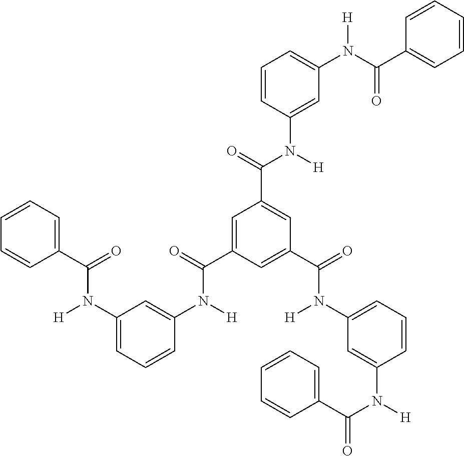 [SMILES: O=C(Nc1cccc(NC(=O)c2cc(C(=O)Nc3cccc(NC(=O)c4ccccc4)c3)cc(C(=O)Nc3cccc(NC(=O)c4ccccc4)c3)c2)c1)c1ccccc1] | N1,N3,N5-tris(3- benzamidophenyl)benzene- 1,3,5-tricarboxamide |
| O1 | 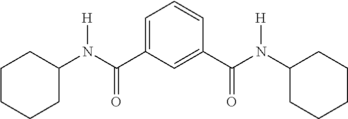 [SMILES: O=C(NC1CCCCC1)c1cccc(C(=O)NC2CCCCC2)c1] | 1,3- Benzenedicarboxamide, N1,N3-dicyclohexyl |
| O2 | 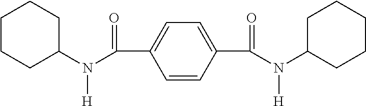 [SMILES: O=C(NC1CCCCC1)c1ccc(C(=O)NC2CCCCC2)cc1] | 1,4- Benzenedicarboxamide, N1,N3-dicyclohexyl |

The relative amount of the aromatic amide oligomer in the composition may be selected to help achieve a balance between strength and melt rheology. In most embodiments, for example, the aromatic amide oligomer, or mixtures thereof, may be employed in an amount of from about 0.1 to about 10 parts, in some embodiments from about 0.5 to about 8 parts, and in some embodiments, from about 1 to about 5 parts by weight relative to 100 parts by weight of the liquid crystalline polymer. The aromatic amide oligomer may, for example, constitute from about 0.1 wt. % to about 10 wt. %, in some embodiments from about 0.2 wt. % to about 8 wt. %, in some embodiments from about 0.3 wt. % to about 5 wt. %, and in some embodiments, from about 0.4 wt. % to about 3 wt. % of the polymer composition. Likewise, liquid crystalline polymers may constitute from about 30 wt. % to about 95 wt. %, in some embodiments from about 40 wt. % to about 90 wt. %, and in some embodiments, from about 50 wt. % to about 80 wt. % of the polymer composition.

C. Fibrous Filler

A fibrous filler is employed in the polymer composition of the present invention to improve the mechanical properties. The fibers of such a filler generally have a high degree of tensile strength relative to their mass. For example, the ultimate tensile strength of the fibers (determined in accordance with ASTM D2101) is typically from about 1,000 to about 15,000 Megapascals (“MPa”), in some embodiments from about 2,000 MPa to about 10,000 MPa, and in some embodiments, from about 3,000 MPa to about 6,000 MPa. To help maintain an insulative property, which is often desirable for use in electronic components, the high strength fibers may be formed from materials that are also generally insulative in nature, such as glass, ceramics (e.g., alumina or silica), aramids (e.g., Kevlar® marketed by E. I. du Pont de Nemours, Wilmington, Del.), polyolefins, polyesters, etc., as well as mixtures thereof. Glass fibers are particularly suitable, such as E-glass, A-glass, C-glass, D-glass, AR-glass, R-glass, S1-glass, S2-glass, etc., and mixtures thereof.

The volume average length of the fibers may be from about 50 to about 400 micrometers, in some embodiments from about 80 to about 250 micrometers, in some embodiments from about 100 to about 200 micrometers, and in some embodiments, from about 110 to about 180 micrometers. The fibers may also have a narrow length distribution. That is, at least about 70% by volume of the fibers, in some embodiments at least about 80% by volume of the fibers, and in some embodiments, at least about 90% by volume of the fibers have a length within the range of from about 50 to about 400 micrometers, in some embodiments from about 80 to about 250 micrometers, in some embodiments from about 100 to about 200 micrometers, and in some embodiments, from about 110 to about 180 micrometers. The fibers may also have a relatively high aspect ratio (average length divided by nominal diameter) to help improve the mechanical properties of the resulting polymer composition. For example, the fibers may have an aspect ratio of from about 2 to about 50, in some embodiments from about 4 to about 40, and in some embodiments, from about 5 to about 20 are particularly beneficial. The fibers may, for example, have a nominal diameter of about 10 to about 35 micrometers, and in some embodiments, from about 15 to about 30 micrometers.

The relative amount of the fibrous filler in the polymer composition may also be selectively controlled to help achieve the desired mechanical properties without adversely impacting other properties of the composition, such as its flowability. For example, the fibrous filler may constitute from about 2 wt. % to about 40 wt. %, in some embodiments from about 5 wt. % to about 35 wt. %, and in some embodiments, from about 6 wt. % to about 30 wt. % of the polymer composition. Although the fibrous filler may be employed within the ranges noted above, small fiber contents may be employed while still achieving the desired mechanical properties. For example, the fibrous filler can be employed in small amounts such as from about 2 wt. % to about 20 wt. %, in some embodiments, from about 5 wt. % to about 16 wt. %, and in some embodiments, from about 6 wt. % to about 12 wt. %.

D. Other Additives

In addition to the components identified above, various other additives may also be incorporated in the polymer composition if desired. Mineral fillers may, for instance, be employed in the polymer composition to help achieve the desired mechanical properties and/or appearance. When employed, mineral fillers typically constitute from about 5 wt. % to about 60 wt. %, in some embodiments from about 10 wt. % to about 55 wt. %, and in some embodiments, from about 20 wt. % to about 50 wt. % of the polymer composition. Clay minerals may be particularly suitable for use in the present invention. Examples of such clay minerals include, for instance, talc (Mg₃Si₄O₁₀(OH)₂), halloysite (Al₂Si₂O₅(OH)₄), kaolinite (Al₂Si₂O₅(OH)₄), illite ((K,H₃O)(Al,Mg,Fe)₂(Si,Al)₄O₁₀[(OH)₂,(H₂O)]), montmorillonite (Na,Ca)_{0.33}(Al,Mg)₂Si₄O₁₀(OH)₂.nH₂O), vermiculite ((MgFe,Al)₃(Al,Si)₄O₁₀(OH)₂.4H₂O), palygorskite ((Mg,Al)₂Si₄O₁₀(OH).4(H₂O)), pyrophyllite (Al₂Si₄O₁₀(OH)₂), etc., as well as combinations thereof. In lieu of, or in addition to, clay minerals, still other mineral fillers may also be employed. For example, other suitable silicate fillers may also be employed, such as calcium silicate, aluminum silicate, mica, diatomaceous earth, wollastonite, and so forth. Mica, for instance, may be particularly suitable. There are several chemically distinct mica species with considerable variance in geologic occurrence, but all have essentially the same crystal structure. As used herein, the term “mica” is meant to generically include any of these species, such as muscovite (KAl₂(AlSi₃)O₁₀(OH)₂), biotite (K(Mg,Fe)₃(AlSi₃)O₁₀(OH)₂), phlogopite (KMg₃(AlSi₃)O₁₀(OH)₂), lepidolite (K(Li,Al)₂.3(AlSi₃)O₁₀(OH)₂), glauconite (K,Na)(Al,Mg,Fe)₂(Si,Al)₄O₁₀(OH)₂), etc., as well as combinations thereof.

Still other additives that can be included in the composition may include, for instance, antimicrobials, pigments (e.g., carbon black), antioxidants, stabilizers, surfactants, waxes, solid solvents, and other materials added to enhance properties and processability. Lubricants, for instance, may be employed in the polymer composition. Examples of such lubricants include fatty acids esters, the salts thereof, esters, fatty acid amides, organic phosphate esters, and hydrocarbon waxes of the type commonly used as lubricants in the processing of engineering plastic materials, including mixtures thereof. Suitable fatty acids typically have a backbone carbon chain of from about 12 to about 60 carbon atoms, such as myristic acid, palmitic acid, stearic acid, arachic acid, montanic acid, octadecinic acid, parinric acid, and so forth. Suitable esters include fatty acid esters, fatty alcohol esters, wax esters, glycerol esters, glycol esters and complex esters. Fatty acid amides include fatty primary amides, fatty secondary amides, methylene and ethylene bisamides and alkanolamides such as, for example, palmitic acid amide, stearic acid amide, oleic acid amide, N,N′-ethylenebisstearamide and so forth. Also suitable are the metal salts of fatty acids such as calcium stearate, zinc stearate, magnesium stearate, and so forth; hydrocarbon waxes, including paraffin waxes, polyolefin and oxidized polyolefin waxes, and microcrystalline waxes. Particularly suitable lubricants are acids, salts, or amides of stearic acid, such as pentaerythritol tetrastearate, calcium stearate, or N,N′-ethylenebisstearamide. When employed, the lubricant(s) typically constitute from about 0.05 wt. % to about 1.5 wt. %, and in some embodiments, from about 0.1 wt. % to about 0.5 wt. % (by weight) of the polymer composition.

### II. Melt Blending

As indicated above, the flow aid (e.g., aromatic amide oligomer) and fibrous filler are melt blended with the liquid crystalline polymer in a selectively controlled manner to achieve a combination of high flow and good thermo-mechanical properties. Melt blending typically occurs within a temperature range of from about 200° C. to about 450° C., in some embodiments, from about 220° C. to about 400° C., and in some embodiments, from about 250° C. to about 350° C. to form the polymer composition. Any of a variety of melt blending techniques may generally be employed in the present invention. For example, the components may be melt blended within an extruder that includes at least one screw rotatably mounted and received within a barrel (e.g., cylindrical barrel) and may define a feed section and a melting section located downstream from the feed section along the length of the screw. The extruder may be a single screw or twin screw extruder.

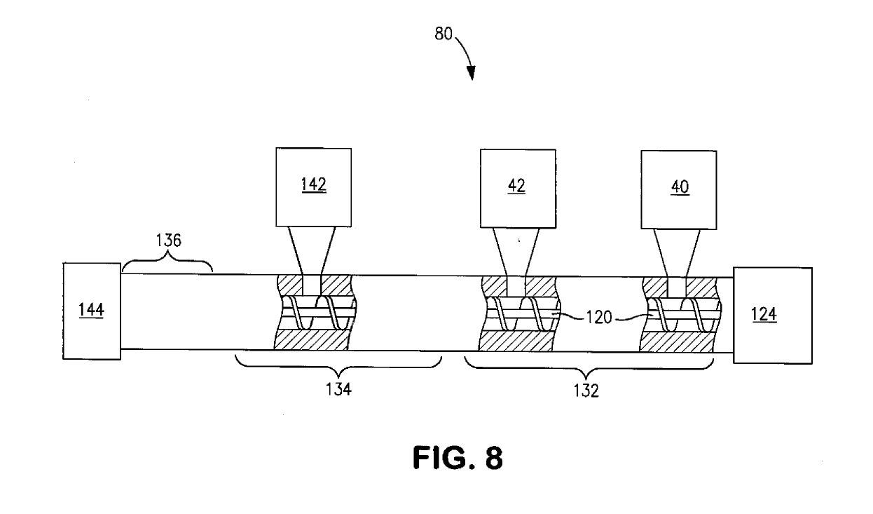

Referring to FIG. 8, for example, one embodiment of a single screw extruder 80 is shown that contains a housing or barrel 114 and a screw 120 rotatably driven on one end by a suitable drive 124 (typically including a motor and gearbox). If desired, a twin-screw extruder may be employed that contains two separate screws. The configuration of the screw is not particularly critical to the present invention and it may contain any number and/or orientation of threads and channels as is known in the art. As shown, for example, the screw 120 contains a thread that forms a generally helical channel radially extending around a core of the screw 120. A hopper 40 is located adjacent to the drive 124 for supplying a liquid crystalline polymer through an opening in the barrel 114 to the feed section 132. Opposite the drive 124 is the output end 144 of the extruder 80, where extruded plastic is output for further processing. If desired, the ratio of the total length (“L”) of the screw 120 to its diameter (“D”) may be selected to achieve an optimum balance between throughput and fiber length reduction. The L/D value may, for instance, range from about 15 to about 50, in some embodiments from about 20 to about 45, and in some embodiments from about to about 40. The length of the screw may, for instance, range from about 0.1 to about 5 meters, in some embodiments from about 0.4 to about 4 meters, and in some embodiments, from about 0.5 to about 2 meters. The diameter of the screw may likewise be from about 5 to about 150 millimeters, in some embodiments from about 10 to about 120 millimeters, and in some embodiments, from about 20 to about 80 millimeters.

A feed section 132 and melt section 134 are defined along the length of the screw 120. The feed section 132 is the input portion of the barrel 114 where the base liquid crystalline polymer is added. The melt section 134 is the phase change section in which the liquid crystalline polymer is changed from a solid to a liquid. While there is no precisely defined delineation of these sections when the extruder is manufactured, it is well within the ordinary skill of those in this art to reliably identify the feed section 132 and the melt section 134 in which phase change from solid to liquid is occurring. Although not necessarily required, the extruder 80 may also have a mixing section 136 that is located adjacent to the output end of the barrel 114 and downstream from the melt section 134. If desired, one or more distributive and/or dispersive mixing elements may be employed within the mixing and/or melting sections of the extruder. Suitable distributive mixers for single screw extruders may include, for instance, Saxon, Dulmage, Cavity Transfer mixers, etc. Likewise, suitable dispersive mixers may include Blister ring, Leroy/Maddock, CRD mixers, etc. As is well known in the art, the mixing may be further improved by using pins in the barrel that create a folding and reorientation of the polymer melt, such as those used in Buss Kneader extruders, Cavity Transfer mixers, and Vortex Intermeshing Pin mixers.

The fibrous filler may be added in conjunction with the liquid crystalline polymer or at a location downstream therefrom. In one particular embodiment, the fibrous filler may be added a location downstream from the point at which the liquid crystalline polymer is supplied, but yet prior to the melting section. In FIG. 8, for instance, a hopper 42 is shown that is located within a zone of the feed section 132 of the extruder 80, but downstream from the hopper 40 where the liquid crystalline polymer is supplied. In one particular embodiment, the fibrous filler (not shown) may be supplied to the hopper 42. To allow for sufficient mixing of the fibrous filler and the polymer, the L/D ratio of the screw after the point at which the fibrous filler is supplied may be controlled within a certain range. For example, the screw may have a first blending length (“L₁”) that is defined from the point at which the fibrous filler is supplied to the extruder to the end of the screw, the blending length being less than the total length of the screw. As noted above, it may be desirable to add the fibrous filler before the liquid crystalline polymer is melted, which means that the L₁/D ratio would be relatively high. However, too high of a L₁/D ratio could result in degradation of the polymer. Therefore, the L₁/D ratio of the screw after the point at which the fibrous filler is supplied is typically from about 15 to about 35, in some embodiments from about 18 to about 32, and in some embodiments, from about 20 to about 30.

Likewise, as indicated above, the flow aid is supplied to the extruder at a location downstream from the fibrous filler and the liquid crystalline polymer. Referring again to FIG. 8, for instance, the flow aid may be added at any section of the extruder, such as to the feed section 132, melt section 134, and/or mixing section 136. In one embodiment, for example, the flow aid may be added to a hopper 142 that is located within a zone of the melt section 134 of the extruder 80, but downstream from the hoppers 40 and 42. The L/D ratio of the screw after the point at which the flow aid is supplied may be controlled within a certain range to ensure that the filler and the polymer have a sufficient time to mix. For example, the screw may have a second blending length (“L₂”) that is defined from the point at which the flow aid is supplied to the extruder to the end of the screw, the blending length being less than the total length of the screw. As noted above, it is desirable to add the flow aid downstream from the fibrous filler and the polymer, which means that the L₂/D ratio would be relatively low. However, too low of a L₂/D ratio could result in a polymer composition have too high of a melt viscosity. Therefore, the L₂/D ratio of the screw after the point at which the oligomer is supplied is typically from about 5 to about 25, in some embodiments from about 8 to about 22, and in some embodiments, from about 10 to about 20.

Of course, other aspects of the extruder may also be selected to help achieve the desired melt viscosity and dispersion of the fibrous filler. For example, the speed of the screw may be selected to achieve the desired residence time, shear rate, melt processing temperature, etc. Generally, an increase in frictional energy results from the shear exerted by the turning screw on the materials within the extruder and results in increased dispersion. The degree of dispersion may depend, at least in part, on the screw speed. For example, the screw speed may range from about 50 to about 200 revolutions per minute (“rpm”), in some embodiments from about 70 to about 150 rpm, and in some embodiments, from about 80 to about 120 rpm. The apparent shear rate during melt blending may also range from about 100 seconds⁻¹ to about 10,000 seconds⁻¹, in some embodiments from about 500 seconds⁻¹ to about 5000 seconds⁻¹, and in some embodiments, from about 800 seconds⁻¹ to about 1200 seconds⁻¹. The apparent shear rate is equal to 4Q/πR³, where Q is the volumetric flow rate (“m³/s”) of the polymer melt and R is the radius (“m”) of the capillary (e.g., extruder die) through which the melted polymer flows.

The resulting polymer composition generally possesses properties that facilitate its use in forming molded parts. For example, the composition may possess a high impact strength, which is useful when forming the thin walls of fine pitch connectors. The composition may, for instance, possess a Charpy notched impact strength greater than about 10 kJ/m², in some embodiments from about 20 to about 80 kJ/m², and in some embodiments, from about 30 to about 60 kJ/m², measured at 23° C. according to ISO Test No. 179-1) (technically equivalent to ASTM D256, Method B). The tensile and flexural mechanical properties of the composition are also good. For example, the polymer composition may exhibit a tensile strength of from about 50 to about 500 MPa, in some embodiments from about 100 to about 250 MPa, and in some embodiments, from about 120 to about 200 MPa; a tensile break strain of about 0.5% or more, in some embodiments from about 0.6% to about 10%, and in some embodiments, from about 0.8% to about 3.5%; and/or a tensile modulus of from about 5,000 MPa to about 20,000 MPa, in some embodiments from about 8,000 MPa to about 20,000 MPa, and in some embodiments, from about 10,000 MPa to about 15,000 MPa. The tensile properties may be determined in accordance with ISO Test No. 527 (technically equivalent to ASTM D638) at 23° C. The polymer composition may also exhibit a flexural strength of from about 20 to about 500 MPa, in some embodiments from about 50 to about 400 MPa, and in some embodiments, from about 100 to about 350 MPa; a flexural break strain of about 0.5% or more, in some embodiments from about 0.6% to about 10%, and in some embodiments, from about 0.8% to about 3.5%; and/or a flexural modulus of from about 5,000 MPa to about 30,000 MPa, in some embodiments from about 8,000 MPa to about 25,000 MPa, and in some embodiments, from about 10,000 MPa to about 20,000 MPa. The flexural properties may be determined in accordance with ISO Test No. 178 (technically equivalent to ASTM D790) at 23° C.

The melting temperature of the composition may likewise be from about 250° C. to about 400° C., in some embodiments from about 270° C. to about 380° C., and in some embodiments, from about 300° C. to about 360° C. The melting temperature may be determined as is well known in the art using differential scanning calorimetry (“DSC”), such as determined by ISO Test No. 11357. Even at such melting temperatures, the ratio of the deflection temperature under load (“DTUL”), a measure of short term heat resistance, to the melting temperature may still remain relatively high. For example, the ratio may range from about 0.65 to about 1.00, in some embodiments from about 0.70 to about 0.95, and in some embodiments, from about 0.75 to about 0.85. The specific DTUL values may, for instance, range from about 240° C. to about 320° C., in some embodiments from about 250° C. to about 300° C., and in some embodiments, from about 260° C. to about 290° C. Such high DTUL values can, among other things, allow the use of high speed processes often employed during the manufacture of connectors.

### III. Molded Parts

Once formed, the resulting polymer composition may be molded into any of a variety of different shaped parts using techniques as is known in the art. For example, the shaped parts may be molded using a one-component injection molding process in which dried and preheated plastic granules are injected into the mold. Regardless of the molding technique employed, it has been discovered that the polymer composition of the present invention, which possesses the unique combination of high flowability and good thermo-mechanical properties, is particularly well suited for parts having a small dimensional tolerance. Such parts, for example, generally contain at least one micro-sized dimension (e.g., thickness, width, height, etc.), such as from about 500 micrometers or less, in some embodiments from about 100 to about 450 micrometers, and in some embodiments, from about 200 to about 400 micrometers.

One such part is a fine pitch electrical connector. More particularly, such electrical connectors are often employed to detachably mount a central processing unit (“CPU”) to a printed circuit board. The connector may contain insertion passageways that are configured to receive contact pins. These passageways are defined by opposing walls, which may be formed from a thermoplastic resin. To help accomplish the desired electrical performance, the pitch of these pins is generally small to accommodate a large number of contact pins required within a given space. This, in turn, requires that the pitch of the pin insertion passageways and the width of opposing walls that partition those passageways are also small. For example, the walls may have a width of from about 500 micrometers or less, in some embodiments from about 100 to about 450 micrometers, and in some embodiments, from about 200 to about 400 micrometers. In the past, it has often been difficult to adequately fill a mold of such a thin width with a thermoplastic resin. Due to its unique properties, however, the polymer composition of the present invention is particularly well suited to form the walls of a fine pitch connector.

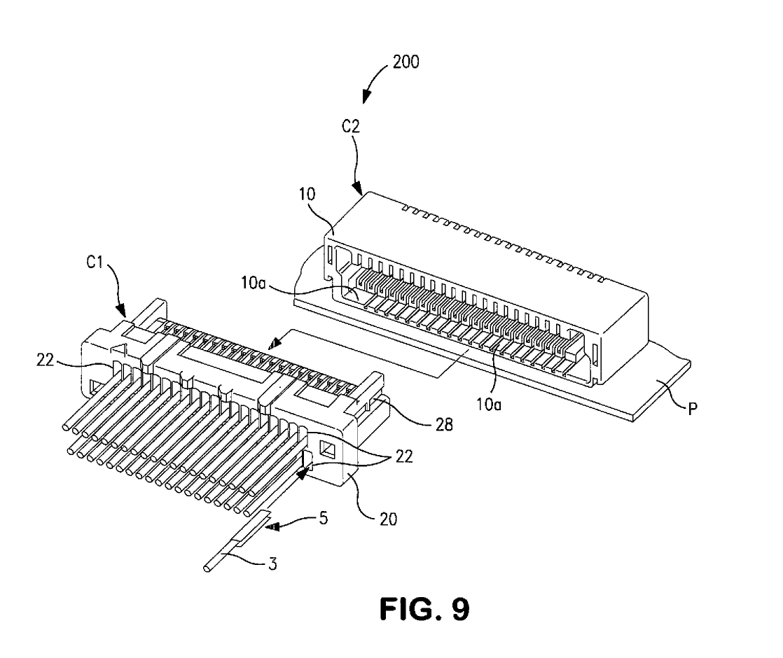

One particularly suitable fine pitch electrical connector is shown in FIG. 9. An electrical connector 200 is shown that a board-side portion C2 that can be mounted onto the surface of a circuit board P. The connector 200 may also include a wiring material-side portion C1 structured to connect discrete wires 3 to the circuit board P by being coupled to the board-side connector C2. The board-side portion C2 may include a first housing 10 that has a fitting recess 10a into which the wiring material-side connector C1 is fitted and a configuration that is slim and long in the widthwise direction of the housing 10. The wiring material-side portion C1 may likewise include a second housing 20 that is slim and long in the widthwise direction of the housing 20. In the second housing 20, a plurality of terminal-receiving cavities 22 may be provided in parallel in the widthwise direction so as to create a two-tier array including upper and lower terminal-receiving cavities 22. A terminal 5, which is mounted to the distal end of a discrete wire 3, may be received within each of the terminal-receiving cavities 22. If desired, locking portions 28 (engaging portions) may also be provided on the housing 20 that correspond to a connection member (not shown) on the board-side connector C2.

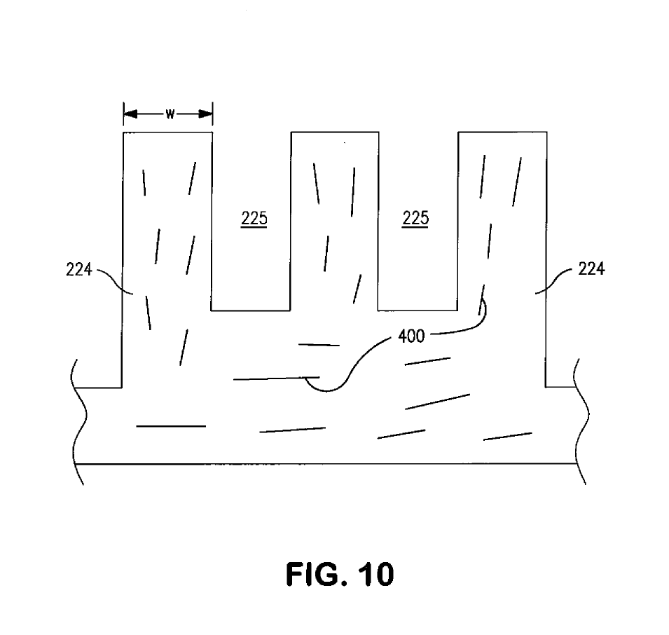

As discussed above, the interior walls of the first housing 10 and/or second housing 20 may have a relatively small width dimension, and can be formed from the polymer composition of the present invention. The walls are, for example, shown in more detail in FIG. 10. As illustrated, insertion passageways or spaces 225 are defined between opposing walls 224 that can accommodate contact pins. The walls 224 have a width “w” that is within the ranges noted above. When the walls 224 are formed from a polymer composition containing fibers (e.g., element 400), such fibers may have a volume average length and narrow length distribution within a certain range to best match the width of the walls. For example, the ratio of the width of at least one of the walls to the volume average length of the fibers is from about 0.8 to about 3.2, in some embodiments from about 1.0 to about 3.0, and in some embodiments, from about 1.2 to about 2.9.

In addition to or in lieu of the walls, it should also be understood that any other portion of the housing may also be formed from the polymer composition of the present invention. For example, the connector may also include a shield that encloses the housing. Some or all of the shield may be formed from the polymer composition of the present invention. For example, the housing and the shield can each be a one-piece structure unitarily molded from the polymer composition. Likewise, the shield can be a two-piece structure that includes a first shell and a second shell, each of which may be formed from the polymer composition of the present invention.

Of course, the polymer composition may also be used in a wide variety of other components having a small dimensional tolerance. For example, the polymer composition may be molded into a planar substrate for use in an electronic component. The substrate may be thin, such as having a thickness of about 500 micrometers or less, in some embodiments from about 100 to about 450 micrometers, and in some embodiments, from about 200 to about 400 micrometers. Examples of electronic components that may employ such a substrate include, for instance, cellular telephones, laptop computers, small portable computers (e.g., ultraportable computers, netbook computers, and tablet computers), wrist-watch devices, pendant devices, headphone and earpiece devices, media players with wireless communications capabilities, handheld computers (also sometimes called personal digital assistants), remote controllers, global positioning system (GPS) devices, handheld gaming devices, battery covers, speakers, integrated circuits (e.g., SIM cards), etc.

In one embodiment, for example, the planar substrate may be applied with one or more conductive elements using a variety of known techniques (e.g., laser direct structuring, electroplating, etc.). The conductive elements may serve a variety of different purposes. In one embodiment, for example, the conductive elements form an integrated circuit, such as those used in SIM cards. In another embodiment, the conductive elements form antennas of a variety of different types, such as antennae with resonating elements that are formed from patch antenna structures, inverted-F antenna structures, closed and open slot antenna structures, loop antenna structures, monopoles, dipoles, planar inverted-F antenna structures, hybrids of these designs, etc. The resulting antenna structures may be incorporated into the housing of a relatively compact portable electronic component, such as described above, in which the available interior space is relatively small.

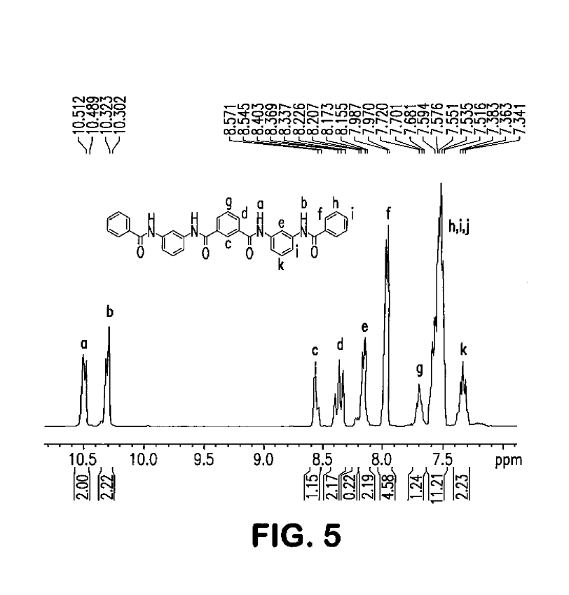

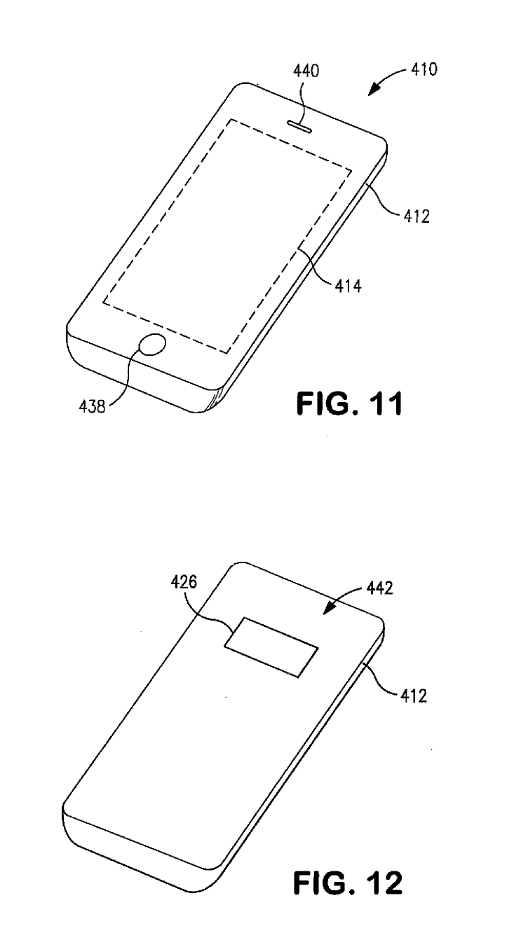

One particularly suitable electronic component that includes an antenna structure is shown in FIGS. 11-12 is a handheld device 410 with cellular telephone capabilities. As shown in FIG. 11, the device 410 may have a housing 412 formed from plastic, metal, other suitable dielectric materials, other suitable conductive materials, or combinations of such materials. A display 414 may be provided on a front surface of the device 410, such as a touch screen display. The device 410 may also have a speaker port 440 and other input-output ports. One or more buttons 438 and other user input devices may be used to gather user input. As shown in FIG. 5, an antenna structure 426 is also provided on a rear surface 442 of device 410, although it should be understood that the antenna structure can generally be positioned at any desired location of the device. As indicated above, the antenna structure 426 may contain a planar substrate that is formed from the polymer composition of the present invention. The antenna structure may be electrically connected to other components within the electronic device using any of a variety of known techniques. For example, the housing 412 or a part of housing 412 may serve as a conductive ground plane for the antenna structure 426.

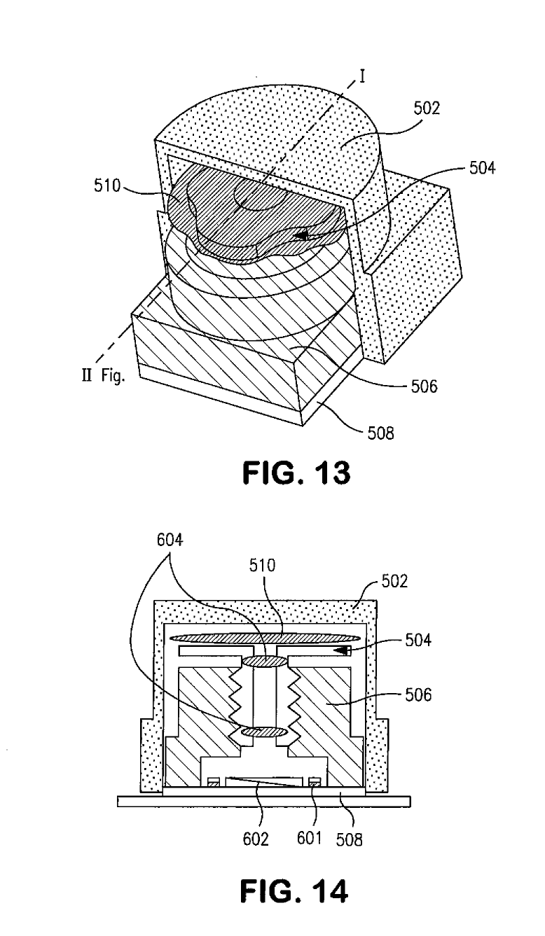

A planar substrate that is formed form the polymer composition of the present invention may also be employed in other applications. For example, in one embodiment, the planar substrate may be used to form a base of a compact camera module (“CCM”), which is commonly employed in wireless communication devices (e.g., cellular phone). Referring to FIGS. 13-14, for example, one particular embodiment of a compact camera module 500 is shown in more detail. As shown, the compact camera module 500 contains a lens assembly 504 that overlies a base 506, The base 506, in turn, overlies an optional main board 508. Due to their relatively thin nature, the base 506 and/or main board 508 are particularly suited to be formed from the polymer composition of the present invention as described above. The lens assembly 504 may have any of a variety of configurations as is known in the art, and may include fixed focus-type lenses and/or auto focus-type lenses. In one embodiment, for example, the lens assembly 504 is in the form of a hollow barrel that houses lenses 604, which are in communication with an image sensor 602 positioned on the main board 508 and controlled by a circuit 601. The barrel may have any of a variety of shapes, such as rectangular, cylindrical, etc. In certain embodiments, the barrel may also be formed from the polymer composition of the present invention and have a wall thickness within the ranges noted above. It should be understood that other parts of the cameral module may also be formed from the polymer composition of the present invention. For example, as shown, a polymer film 510 (e.g., polyester film) and/or thermal insulating cap 502 may cover the lens assembly 504. In some embodiments, the film 510 and/or cap 502 may also be formed from the polymer composition of the present invention.

The present invention may be better understood with reference to the following examples.

### Test Methods

Blister Free Temperature:

To test blister resistance, a 127×12.7 x 0.8 mm test bar is molded at 5° C. to 10° C. higher than the melting temperature of the polymer resin, as determined by DSC. Ten (10) bars are immersed in a silicone oil at a given temperature for 3 minutes, subsequently removed, cooled to ambient conditions, and then inspected for blisters (i.e., surface deformations) that may have formed. The test temperature of the silicone oil begins at 250° C. and is increased at 10° C. increments until a blister is observed on one or more of the test bars. The “blister free temperature” for a tested material is defined as the highest temperature at which all ten (10) bars tested exhibit no blisters. A higher blister free temperature suggests a higher degree of heat resistance.

Melt Viscosity:

The melt viscosity (Pa-s) may be determined in accordance with ISO Test No. 11443 at 350° C. and at a shear rate of 400 s⁻¹ and 1000 s⁻¹ using a Dynisco 7001 capillary rheometer. The rheometer orifice (die) may have a diameter of 1 mm, length of 20 mm, L/D ratio of 20.1, and an entrance angle of 180°. The diameter of the barrel may be 9.55 mm±0.005 mm and the length of the rod may be 233.4 mm.

Intrinsic Viscosity:

The intrinsic viscosity (“IV”) may be measured in accordance with ISO-1628-5 using a 50/50 (v/v) mixture of pentafluorophenol and hexafluoroisopropanol. Each sample may be prepared in duplicate by weighing about 0.02 grams into a 22 mL vial. 10 mL of pentafluorophenol (“PFP”) may be added to each vial and the solvent. The vials may be placed in a heating block set to 80° C. overnight. The following day 10 mL of hexafluoroisopropanol (“HFIP”) may be added to each vial. The final polymer concentration of each sample may be about 0.1%. The samples may be allowed to cool to room temperature and analyzed using a PolyVisc automatic viscometer.

Melting and Crystallization Temperatures:

The melting temperature (“Tm”) and crystallization temperature (“Tc”) may be determined by differential scanning calorimetry (“DSC”) as is known in the art. The melting temperature may be the differential scanning calorimetry (DSC) peak melt temperature as determined by ISO Test No. 11357. The crystallization temperature may be determined from the cooling exotherm in the cooling cycle. Under the DSC procedure, samples may be heated and cooled at 20° C. per minute as stated in ISO Standard 10350 using DSC measurements conducted on a TA Q2000 Instrument.

Tensile Properties:

Tensile properties are tested according to ISO Test No. 527 (technically equivalent to ASTM D638). Modulus and strength measurements are made on the same test strip sample having a length of 80 mm, thickness of 10 mm, and width of 4 mm. The testing temperature is 23° C., and the testing speeds are 1 or 5 mm/min.

Flexural Properties:

Flexural properties are tested according to ISO Test No. 178 (technically equivalent to ASTM D790). This test is performed on a 64 mm support span. Tests are run on the center portions of uncut ISO 3167 multi-purpose bars. The testing temperature is 23° C. and the testing speed is 2 mm/min.

Notched Charpy Impact Strength:

Notched Charpy properties are tested according to ISO Test No. ISO 179-1) (technically equivalent to ASTM D256, Method B). This test is run using a Type A notch (0.25 mm base radius) and Type 1 specimen size (length of 80 mm, width of 10 mm, and thickness of 4 mm). Specimens are cut from the center of a multi-purpose bar using a single tooth milling machine. The testing temperature is 23° C.

Density:

Density was determined according to ISO Test No. 1183 (technically equivalent to ASTM D792). The specimen was weighed in air then weighed when immersed in distilled water at 23° C. using a sinker and wire to hold the specimen completely submerged as required.

Weldline Strength—LGA:

The weldline strength is determined by first forming an injection molded line grid array (“LGA”) connector (size of 49 mm×39 mm×1 mm) from a thermoplastic composition sample as is well known in the art. Once formed, the LGA connector is placed on a sample holder. The center of the connector is then subjected to a tensile force by a rod moving at a speed of 5.08 millimeters per minute. The peak stress is recorded as an estimate of the weldline strength.

Warpage—LGA:

The warpage is determined by first forming an injection molded line grid array (“LGA”) connector (size of 49 mm×39 mm×1 mm) from a thermoplastic composition sample as is well known in the art. A Cores coplanarity measuring module, model core9037a, is used to measure the degree of warpage of the molded part. The test is performed; connector as molded (unaged), and conditioned in 20 minute temperature cycle that ramps from ambient temperature to 270° C., is maintained for 3 minutes and ramped back to room temperature (aged).

### Synthesis of N1,N4-diphenylterephthalamide Compound A

The synthesis of Compound A from terephthaloyl chloride and aniline may be performed according to the following scheme:

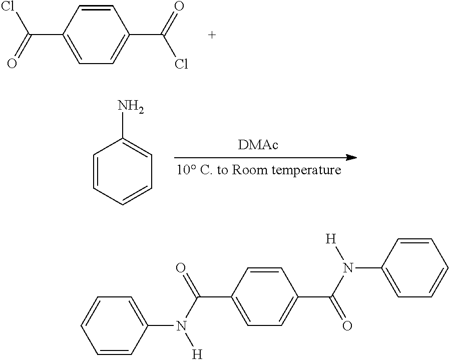

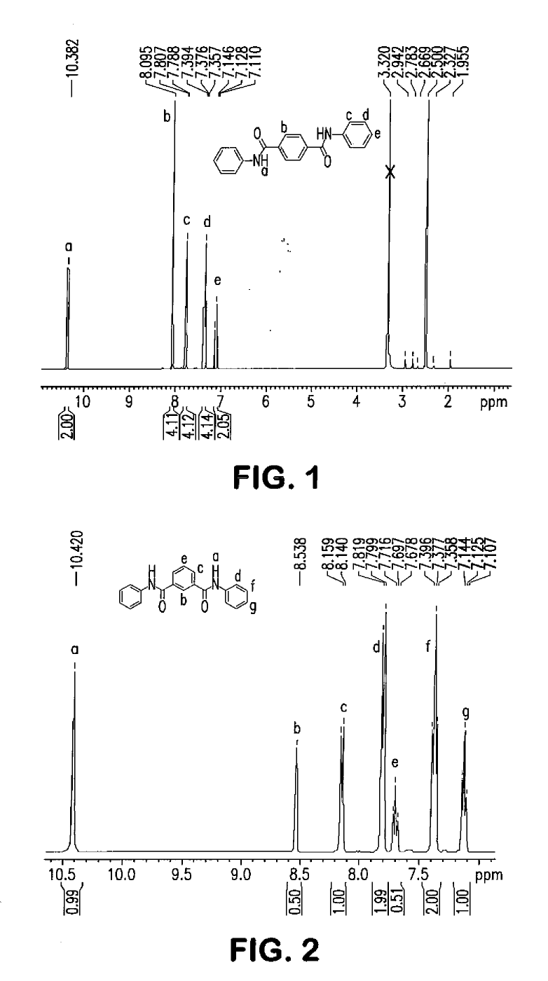

The experimental set up consisted of a 2 L glass beaker equipped with a glass rod stirrer coupled with an overhead mechanical stirrer. Dimethyl acetamide (“DMAc”) (3 L) was added to the beaker and the beaker was immersed in an ice bath to cool the system to 10-15° C. Then aniline (481.6 g) was added to the solvent with constant stirring, the resultant mixture was cooled to 10-15° C. Terephthaloyl chloride (300 g) was added gradually to the cooled stirred mixture such that the temperature of the reaction was maintained below 30° C. The acid chloride was added over a period of one-two hours, after which the mixture was stirred for another three hours at 10-15° C. and then at room temperature overnight. The reaction mixture was milky white (a fine suspension of the product in the solvent) and was vacuum filtered using a filter paper and a Buchner funnel. The crude product was washed with acetone (2 L) and then washed with hot water (2 L). The product was then air dried over night at room temperature and then was dried in a vacuum oven 150° C. for 4-6 hours. The product (464.2 g) was a highly crystalline white solid. The melting point was 346-348° C., as determined by differential scanning calorimetry (“DSC”). The Proton NMR characterization for the compound is also shown in FIG. 1.

### Synthesis of N1,N4-diphenylisoterephthanalide Compound B

The synthesis of Compound B from isophthaloyl chloride and aniline may be performed according to the following scheme:

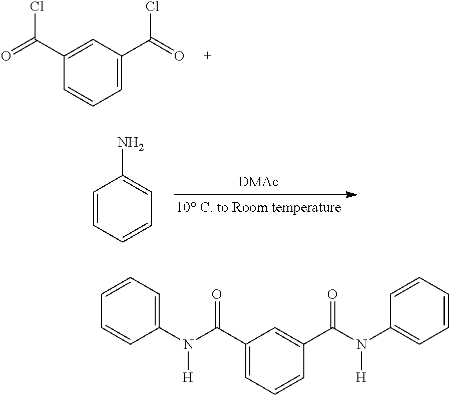

The experimental set up consisted of a 2 L glass beaker equipped with a glass rod stirrer coupled with an overhead mechanical stirrer. DMAc (1.5 L) was added to the beaker and the beaker was immersed in an ice bath to cool the solvent to 10-15° C. Then aniline (561.9 g) was added to the solvent with constant stirring, the resultant mixture was cooled to 10-15° C. Isophthaloyl chloride (350 g dissolved in 200 g of DMAc) was added gradually to the cooled stirred mixture such that the temperature of the reaction was maintained below 30° C. The acid chloride was added over a period of one hour, after which the mixture was stirred for another three hours at 10-15° C. and then at room temperature overnight. The reaction mixture was milky white in appearance. The product was recovered by precipitation by addition of 1.5 L of distilled water and followed by was vacuum filtration using a filter paper and a Buchner funnel. The crude product was then washed with acetone (2 L) and then washed again with hot water (2 L). The product was then air dried over night at room temperature and then was dried in a vacuum oven 150° C. for 4-6 hours. The product (522 g) was a white solid. The melting point was 290° C. as determined by DSC. The Proton NMR characterization for the compound is also shown in FIG. 2.

### Synthesis of N1,N4-bis(2,3,4,5,6-pentafluorophenyl)terephthalamide Compound C

The synthesis of Compound C from pentafluorophenol and terephthaloyl chloride may be performed according to the following scheme:

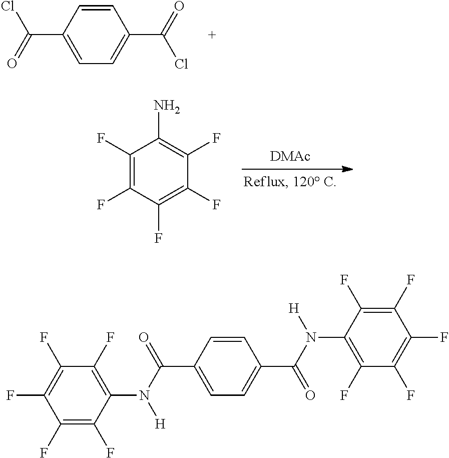

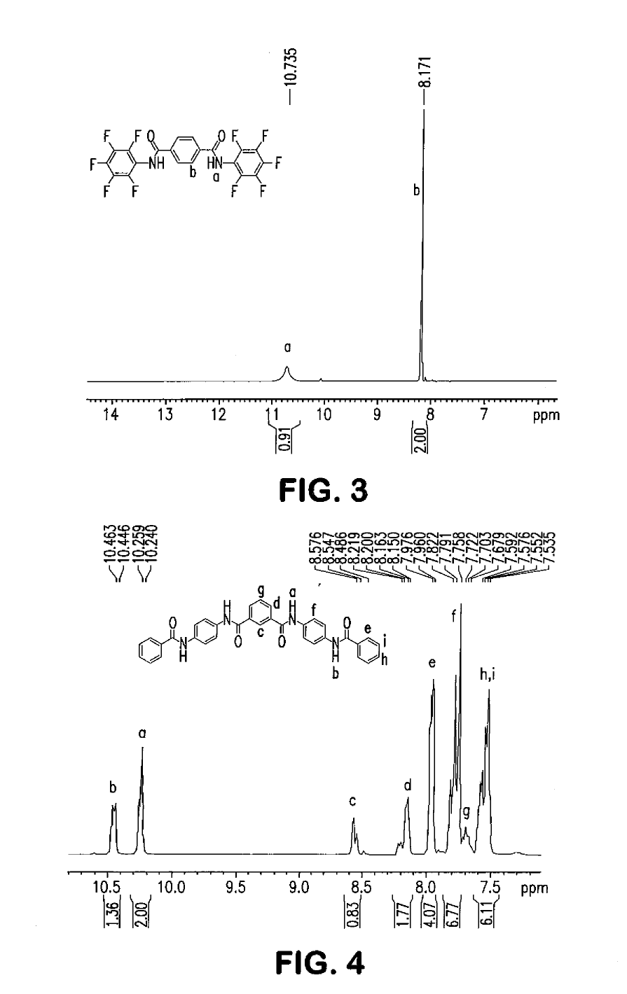

Pentafluoroaniline (10 g) was dissolved in dimethyl acetamide (DMAc) (50 mL) and terephthaloyl chloride (3.7 g) was added in one portion. The reaction mixture was stirred and then refluxed for six (6) hours at 120° C. The reaction mixture was then cooled and 200 mL water was added to the mixture to precipitate the crude product. The product was then filtered and dried. The crude product was then washed with acetone (100 mL) and dried to give a white powder as the final product (6.8 g). The melting point by DSC was 331.6° C. The Proton NMR characterization for the compound is shown in FIG. 3.

### Synthesis of N4-phenyl-N1-[4-[[4-(phenylcarbamoyl)benzoyl]amino]phenyl]terephthalamide Compound E

The synthesis of Compound E from 4-amino benzanilide and terephthaloyl chloride can be performed according to the following scheme:

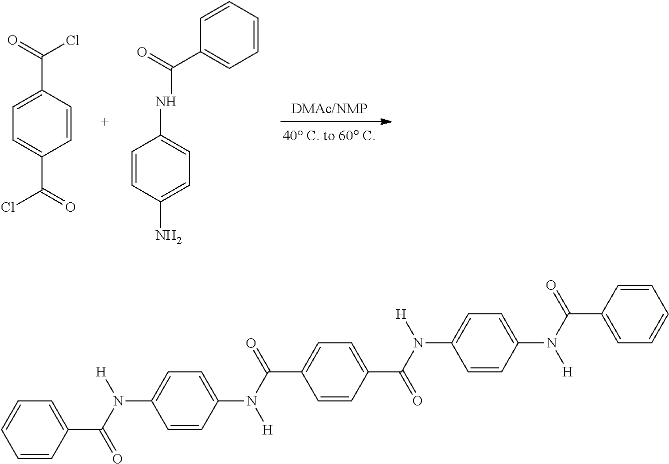 [SMILES: O=C(Cl)c1ccc(C(=O)Cl)cc1 ; Nc1ccc(NC(=O)c2ccccc2)cc1 ; "DMAc/NMP" ; O=C(Nc1ccc(NC(=O)c2ccc(C(=O)Nc3ccc(NC(=O)c4ccccc4)cc3)cc2)cc1)c1ccccc1]

The experimental setup consisted of a 1 L glass beaker equipped with a glass rod stirrer coupled with an overhead mechanical stirrer. 4-aminobenzanilide (20.9 g) was dissolved in warm DMAc (250 mL) (alternatively N-methylpyrrolidone can also be used). Terephthaloyl chloride (10 g) was added to the stirred solution of the diamine maintained at 40-50° C., upon the addition of the acid chloride the reaction temperature increased from 50° C. to 80° C. After the addition of the acid chloride was completed, the reaction mixture was warmed to 70-80° C. and maintained at that temperature for about three hours and allowed to rest overnight at room temperature. The product was then isolated by the addition of water (500 mL) followed by vacuum filtration followed by washing with hot water (1 L). The product was then dried in a vacuum oven at 150° C. for about 6-8 hours, to give a pale yellow colored solid (yield ca. 90%). The melting point by DSC was 462° C.

### Synthesis of N1,N3-bis(4-benzamidophenyl)benzene-1,3-dicarboxamide Compound F2

The synthesis of Compound F2 from 1,4-phenylene diamine, terephthaloyl chloride, and benzoyl chloride may be performed according to the following scheme:

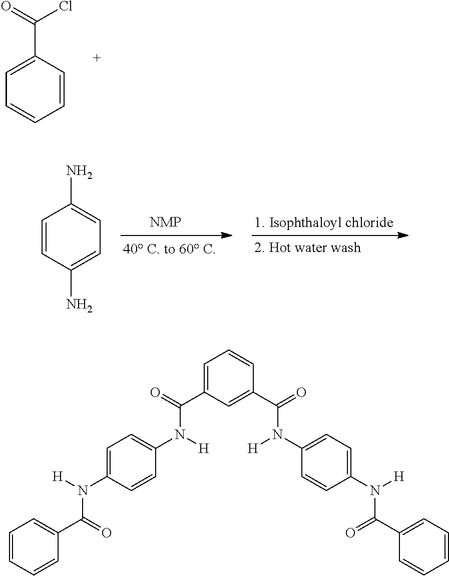

The experimental setup consisted of a 500 mL glass beaker equipped with a magnetic stirrer. 1,4 phenylene diamine (20 g) was dissolved in warm NMP (200 mL) at 40° C. Benzoyl chloride (26.51 g) was added drop wise to a stirred solution of the diamine over a period of 30 minutes. After the addition of the benzoyl chloride was completed, the reaction mixture was warmed to 70-80° C. and then allowed to cool to 50° C. After cooling to the desired temperature, isophthaloyl chloride (18.39 g) was added in small portions such that the temperature of the reaction mixture did not increase above 70° C. The mixture was then stirred for additional one (1) hour at 70° C., and was allowed to rest overnight at room temperature. The product was recovered by addition of water (200 mL) to the reaction mixture, followed by filtration and washing with hot water (500 mL). The product was then dried in a vacuum oven at 150° C. for about 6-8 hours to give a pale yellow colored solid (51 g). The melting point by DSC was 329° C. The Proton NMR characterization for the compound is also shown in FIG. 4.

### Synthesis of N1,N3-bis(3-benzamidophenyl)benzene-1,3-dicarboxamide Compound G2

The synthesis of Compound G2 from 1,3-phenylene diamine, isophthaloyl chloride, and benzoyl chloride may be performed according to the following scheme:

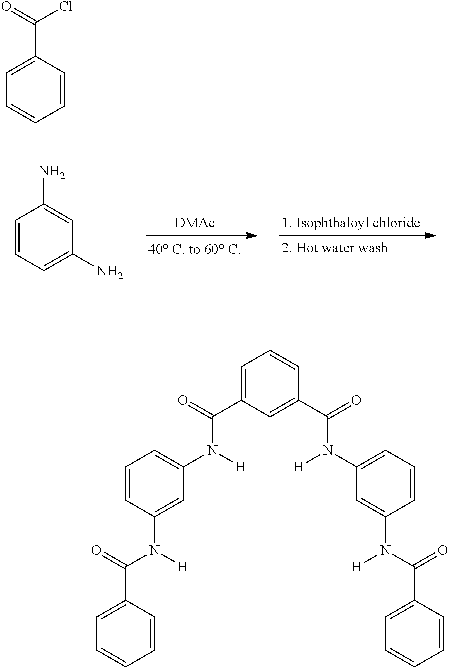

The experimental setup consisted of a 500 mL glass beaker equipped with a magnetic stirrer. 1,3 phenylene diamine (20 g) was dissolved in warm DMAc (200 mL) at 40° C. Benzoyl chloride (26.51 g) was added drop wise to a stirred solution of the diamine over a period of 30 minutes. After the addition of the benzoyl chloride was completed, the reaction mixture was warmed to 70-80° C. and allowed to cool to 50° C. After cooling to the desired temperature, isophthaloyl chloride (18.39 g) was added in small portions such that the temperature of the reaction mixture did not increase above 70° C. The mixture was then stirred for additional one hour at 70° C., and was allowed to rest overnight at room temperature. The product was recovered by addition of water (200 mL) to the reaction mixture, followed by filtration and washing with hot water (500 mL). The product was then dried in a vacuum oven at 150° C. for about 6-8 hours to give a pale yellow colored solid (45 g). The Proton NMR characterization for the compound is also shown in FIG. 5.

### Synthesis of N1,N3,N5-triphenylbenzene-1,3,5-tricarboxamide Compound J

The synthesis of Compound J from trimesoyl chloride and aniline may be performed according to the following scheme:

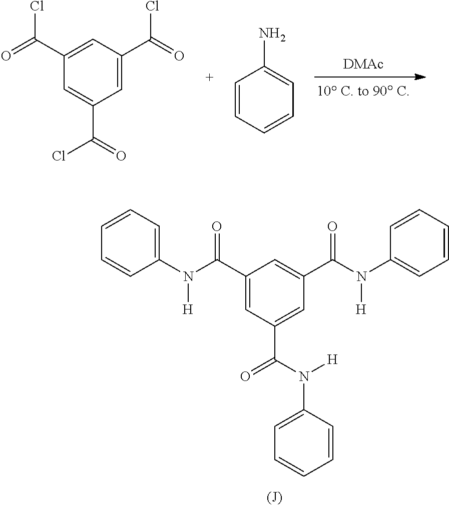

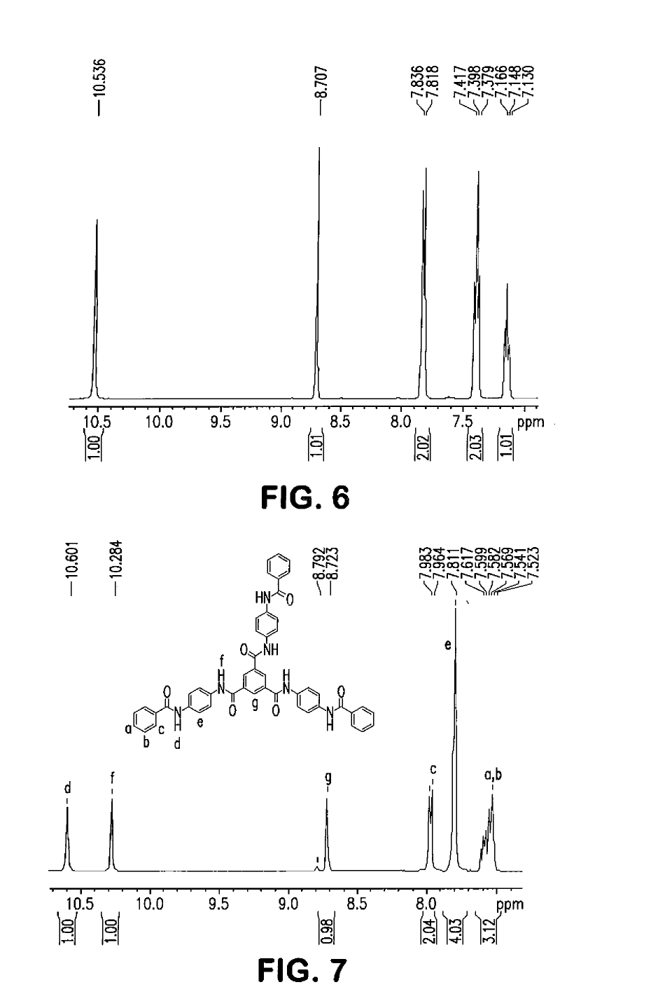

The experimental set up consisted of a 2 L glass beaker equipped with a glass rod stirrer coupled with an overhead mechanical stirrer. Trimesoyl chloride (200 g) was dissolved in dimethyl acetamide (“DMAc”) (1 L) and cooled by an ice bath to 10-20° C. Aniline (421 g) was added drop wise to a stirred solution of the acid chloride over a period of 1.5 to 2 hours. After the addition of the amine was completed, the reaction mixture was stirred additionally for 45 minutes, after which the temperature was increased to 90° C. for about 1 hour. The mixture was allowed to rest overnight at room temperature. The product was recovered by precipitation through the addition of 1.5 L of distilled water, which was followed by was vacuum filtration using a filter paper and a Buchner funnel. The crude product was washed with acetone (2 L) and then washed again with hot water (2 L). The product was then air dried over night at room temperature and then was dried in a vacuum oven 150° C. for 4 to 6 hours. The product (250 g) was a white solid, and had a melting point of 319.6° C., as determined by differential scanning calorimetry (“DSC”). The Proton NMR characterization for the compound is also shown in FIG. 6.

### Synthesis of N1,N3,N5-tris(4-benzamidophenyl)benzene-1,3,5-tricarboxamide Compound K

The synthesis of Compound K from trimesoyl chloride and 4-benzoanilide may be performed according to the following scheme:

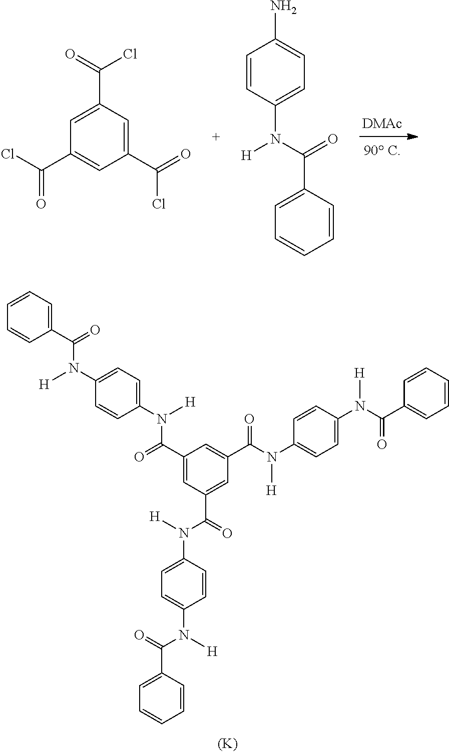

The experimental set up consisted of a 2 L glass beaker equipped with a glass rod stirrer coupled with an overhead mechanical stirrer. Trimesoyl chloride (83.37 g) was dissolved in DMAc (1 L) at room temperature. 4-aminobenzanilide (200 g) was dissolved in DMAc (1 L). The amine solution was gradually added to the acid chloride solution over a period of 15 minutes, and the reaction mixture was then stirred and the temperature increased to 90° C. for about 3 hours. The mixture was allowed to rest overnight at room temperature. The product was recovered by precipitation through the addition of 1.5 L of distilled water, which was followed by was vacuum filtration using a filter paper and a Buchner funnel. The crude product was then washed with acetone (2 L) and washed again with hot water (2 L). The product was then air dried over night at room temperature and then was dried in a vacuum oven 150° C. for 4 to 6 hours. The product (291 g) was a bright yellow solid. No melting point was detected. The Proton NMR characterization for the compound is shown in FIG. 7.

### Synthesis of N1,N3,N5-tris(3-benzamidophenyl)benzene-1,3,5-tricarboxamide Compound N

The synthesis of Compound N from trimesoyl chloride, benzoyl chloride and 1,3-phenylene diamine can be performed according to the following scheme:

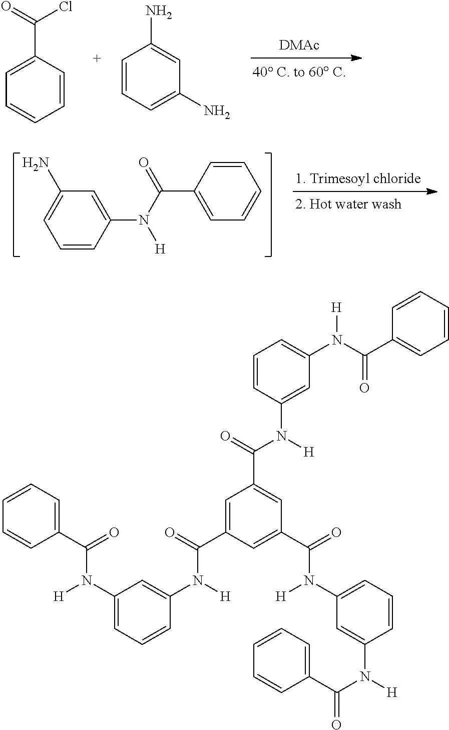

The experimental set up consisted of a 1 L glass beaker equipped with a glass rod stirrer coupled with an overhead mechanical stirrer. 1,3 phenylene diamine (20 g) was dissolved in warm dimethyl acetamide (200 mL) (alternatively N-methylpyrrolidone can also be used) and maintained at 45° C. Next benzoyl chloride (26.51 g) was slowly added drop wise over a period of 1.5 to 2 hours, to the amine solution with constant stirring. The rate of addition of the benzoyl chloride was maintained such that the reaction temperature was maintained less than 60° C. After complete addition of the benzoyl chloride, the reaction mixture was gradually warmed to 85-90° C. and then allowed to cool to around 45-50° C. At this point, trimesoyl chloride (16.03 g) was gradually added to the reaction mixture such that the exotherm did not increase the reaction temperature above 60° C. After complete addition of the trimesoyl chloride, the reaction mixture was allowed to stir for additional 45 minutes, after which the reaction temperature was increased to 90° C. for about 30 minutes and then was cooled to room temperature. The mixture was allowed to rest overnight at room temperature. The product was recovered by precipitation through the addition of 1.5 L of distilled water, which was followed by was vacuum filtration using a filter paper and a Buchner funnel. The crude product was then washed with acetone (250 mL) and washed again with hot water (500 mL). The product (yield: ca. 90%) was then air dried over night at room temperature and then was dried in a vacuum oven 150° C. for 4 to 6 hours. The product was a pale tan solid.

The Proton NMR characterization was as follows: ¹H NMR (400 MHz d₆-DMSO): 10.68 (s, 3H, CONH), 10.3 (s, 3H, CONH), 8.74 (s, 3H, central Ar), 8.1 (d, 3H, m-phenylene Ar), 7.9 (d, 6H, ortho-ArH), 7.51 (m, 15H, meta-para-ArH and 6H, m-phenylene Ar) and 7.36 (m, 3H, m-phenylene Ar).

### Synthesis of 1,3-Benzenedicarboxamide, N1,N3-dicyclohexyl Compound O1

The synthesis of Compound O1 from isophthaloyl chloride and cyclohexyl amine can be performed according to the following scheme:

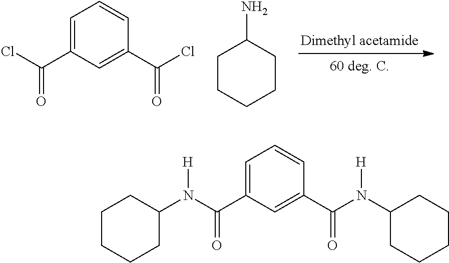

The experimental set up consisted of a 1 L glass beaker equipped with a glass rod stirrer coupled with an overhead mechanical stirrer. Cyclohexyl amine (306 g) was mixed in dimethyl acetamide (1 L) (alternatively N-methylpyrrolidone can also be used) and triethyl amine (250 g) at room temperature. Next isopthaloyl chloride (250 g) was slowly added over a period of 1.5 to 2 hours, to the amine solution with constant stirring. The rate of addition of the acid chloride was maintained such that the reaction temperature was maintained less than 60° C. After complete addition of the benzoyl chloride, the reaction mixture was gradually warmed to 85-90° C. and then allowed to cool to around 45-50° C. The mixture was allowed to rest overnight (for at least 3 hours) at room temperature. The product was recovered by precipitation through the addition of 1.5 L of distilled water, which was followed by was vacuum filtration using a filter paper and a Buchner funnel. The crude product was then washed with acetone (250 mL) and washed again with hot water (500 mL). The product (yield: ca. 90%) was then air dried over night at room temperature and then was dried in a vacuum oven 150° C. for 4 to 6 hours. The product was a white solid. The Proton NMR characterization was as follows: ¹H NMR (400 MHz d₆-DMSO): 8.3 (s, 2H, CONH), 8.22 (s, 1H, Ar), 7.9 (d, 2H, Ar), 7.5 (s, 1H, Ar), 3.7 (broad s, 2H, cyclohexyl), 1.95-1.74 broad s, 4H, cyclohexyl) and 1.34-1.14 (m, 6H, cyclohexyl).

### Example 1

A wholly aromatic liquid crystalline polyester (available commercially from Ticona, LLC) is initially heated to 120° C. and then powder coated with a pentaerythritol tetrastearate lubricant (Glycolube® P available from Lonza, Inc.). Compound A and glass fibers are thereafter melt blended with the polymer so that the final composition contains 68.3 wt. % liquid crystalline polymer, 0.3 wt. % lubricant, 30 wt. % glass fibers, and 1.4 wt. % of Compound A. Fiberglass is 3 mm chopped strand E glass with a 10 micron diameter (available from Nippon Electric Glass Co Ltd). The samples are melt-blended using a Coperion 32-mm co-rotating fully intermeshing twin screw extruder having eleven (11) temperature control zones, including one at the extrusion die. The extruder has an overall L/D of 40, with potential feed zones at an L/D of 1, 16, and 24; shear zones at an L/D of 12, 20, 28, and 32; and a degassing/vacuum zone at an L/D of 36. The polymer pellets are fed at an L/D of 1 and the glass fibers are fed at an L/D of 16 via a gravimetric feeder. Compound A is fed via two different protocols. In the first protocol, Compound A is fed in conjunction with the polymer pellets at an L/D of 1. In the second protocol, Compound A is fed at an L/D of 24. Following melt blending, the samples are quenched in a water bath to solidify and granulated in a pelletizer. All compositions are compounded at a rate of 140 pounds per hour, with a barrel temperature of 290° C. in the glass fiber mixing zone and a screw speed of 450 RPM.

### Example 2

A wholly aromatic liquid crystalline polyester (available commercially from Ticona, LLC) is initially heated to 120° C. and then powder coated with a pentaerythritol tetrastearate lubricant (Glycolube® P available from Lonza, Inc.). Compound K and glass fibers are thereafter melt blended with the polymer so that the final composition contains 68.95 wt. % liquid crystalline polymer, 0.3 wt. % lubricant, 30 wt. % glass fibers, and 0.75 wt. % of Compound K. Fiberglass is 3 mm chopped strand E glass with a 10 micron diameter (available from Nippon Electric Glass Co Ltd). The samples are melt-blended using the same extruder employed in Example 1. The polymer pellets are fed at an L/D of 1, the glass fibers are fed at an L/D of 16, and Compound K is fed at an L/D of 24. Following melt blending, the samples are quenched in a water bath to solidify and granulated in a pelletizer. All compositions are compounded at a rate of 140 pounds per hour, with a barrel temperature of 290° C. in the glass fiber mixing zone and a screw speed of 450 RPM.

### COMPARATIVE EXAMPLES 1-3

A sample is formed as described in Example 1 except that Compound A is not employed (Comp. Ex. 1). Samples are also formed as described in Example 1 except that 4,4′-biphenol is employed rather than Compound A. More particularly, Comp. Ex. 2 involves feeding 4,4′-biphenol in conjunction with the polymer pellets (L/D of 1) and Comp. Ex. 3 involves feeding 4,4′-biphenol downstream of the glass fibers and polymer pellets (L/D of 24).

The processing conditions for all of the examples are summarized in the following table.

| | Example | | | | | |
|---|---|---|---|---|---|---|
| | Comp. | Comp. | Comp. | | | |
| | Ex. 1 | Ex. 2 | Ex. 3 | 1 | 2 | 3 |
| L/D of Polymer Feed | 1 | 1 | 1 | 1 | 1 | 1 |
| L/D of Glass Fiber | 16 | 16 | 16 | 16 | 16 | 16 |
| Feed | | | | | | |
| L/D of Compound A | — | — | — | 1 | 24 | — |
| Feed | | | | | | |
| L/D of Compound K | — | — | — | — | — | 24 |
| Feed | | | | | | |
| L/D of 4,4′-Biphenol | — | 1 | 24 | — | — | — |
| Feed | | | | | | |
| Screw Speed | 450 | 450 | 450 | 450 | 450 | 450 |
| Throughput Rate | 140 | 140 | 140 | 140 | 140 | 140 |
| Fiber mixing | 290 | 290 | 290 | 290 | 290 | 290 |
| temperature (° C.) | | | | | | |
| Torque (%) | 32-34 | 34-36 | 34-35 | 32-35 | 32-35 | 32-35 |
| Melt Temperature | 341 | 339 | 341 | 343 | 341 | 340 |
| (° C.) | | | | | | |

Following formation, the compositions are dried for 3 hours at 120° C. and tested for and scanning shear capillary melt viscosity at 350° C., which is provided in the table below. The pellets are thereafter injection molded to obtain specimens for tensile, impact, flexural and deflection temperature under load measurements as well as blister performance. All compositions are injection molded at ISO 294 conditions. The pellets were first dried for 3 hours at 120° C. The following conditions are used to mold the test specimens: Barrel Temperature—315° C.; Mold Temperature—100° C.; Back Pressure—50 psi; Hold Pressure—10,000 psi; Hold Pressure Time—5 sec; Cooling Time—25 sec; and Cycle Time—sec. The following table shows the resulting thermal and mechanical properties.

| | Example | | | | | |
|---|---|---|---|---|---|---|
| | Comp. | Comp. | Comp. | | | |
| | Ex. 1 | Ex. 2 | Ex. 3 | Ex. 1 | Ex. 2 | Ex. 3 |
| Ash (%) | 29.6 | 29.9 | 29.6 | 29.7 | 29.5 | 29.7 |
| Melt Viscosity (Pa- | 37.2 | 24.5 | 28.2 | 6.4 | 13.1 | 18.7 |
| sec at 350° C. and | | | | | | |
| 1000 s⁻¹) | | | | | | |
| Melt Viscosity (Pa- | 55.4 | 36.2 | 39.2 | 9.8 | 18.2 | 29.4 |
| sec at 350° C. and | | | | | | |
| 400 s⁻¹) | | | | | | |
| Pellet Density (g/cc) | 1.564 | 1.562 | 1.568 | 1.560 | 1.558 | 1.553 |
| Density (%) | 96.3 | 96.2 | 96.5 | 96.1 | 95.9 | 95.6 |
| Melt Temperature | 333.2 | 333.4 | 332.8 | 318.6 | 323.0 | 331.8 |
| (° C.) | | | | | | |
| Crystallinity | 295.2 | 294.1 | 294.8 | 284.8 | 289.5 | 287.4 |
| Temperature (° C.) | | | | | | |
| Blister Free | 270 | 250 | 260 | 240 | 280 | 270 |
| Temperature (° C.) | | | | | | |
| Tensile Strength | 165 | 143 | 150 | 126 | 163 | 164 |
| (MPa) | | | | | | |
| Tensile Elongation | 1.72 | 1.55 | 1.49 | 1.31 | 1.80 | 2.04 |
| (%) | | | | | | |
| Tensile Modulus | 16650 | 13950 | 14550 | 14900 | 16550 | 16450 |
| (MPa) | | | | | | |
| Flexural Strength | 230.57 | 204.21 | 212.32 | 204.31 | 230.13 | 232.95 |
| (MPa) | | | | | | |
| Flexural Modulus | 17000 | 14950 | 15250 | 15100 | 16550 | 16600 |
| (MPa) | | | | | | |
| Notched Charpy | 36 | 29 | 27 | 10 | 37 | 36 |
| Impact Strength | | | | | | |
| (kJ/m²) | | | | | | |
| DTUL (° C.) | 265 | 250 | 252 | 234 | 265 | 267 |
| Peak Pressure to | 8260 | 7890 | 8300 | 4940 | 6085 | 6060 |
| Fill (psi) | | | | | | |
| Maximum Load | 11.1 | 11.5 | 10.6 | 10.7 | 11.2 | 10.9 |
| Point (lb-f) | | | | | | |
| Warpage Unaged - | 0.913 | 0.955 | 0.904 | 0.727 | 0.820 | 0.905 |
| LGA (mm) | | | | | | |
| Warpage Aged - | 2.437 | 2.643 | 2.479 | 2.163 | 1.962 | 2.189 |
| LGA (mm) | | | | | | |

As indicated, the melt viscosity can be reduced by almost 80% when Compound A is fed at 1 L/D. When Compounds A and K are fed downstream at 24 L/D (Examples 2 and 3), a substantial reduction in melt viscosity is also observed. Furthermore, Examples 2 and 3 also exhibited excellent mechanical and thermal properties (e.g., BFT) due to the addition of Compound A or K after dispersion of the glass fibers. In contrast, the use of 4,4′-biphenol resulted in a substantial reduction in mechanical properties, even when added after fiber dispersion (Comp. Ex. 3).

These and other modifications and variations of the present invention may be practiced by those of ordinary skill in the art, without departing from the spirit and scope of the present invention. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

1. A method for forming a polymer composition within an extruder, the extruder containing at least one rotatable screw within a barrel, the method comprising:
supplying a thermotropic liquid crystalline polymer and a fibrous filler to the extruder;
blending the polymer and the fibrous filler within the extruder; and
thereafter, supplying a flow aid to the extruder at a location that is downstream from the polymer and the fibrous filler, wherein the flow aid includes an aromatic amide oligomer.

2. The method of claim 1, wherein the screw has a total length and diameter, wherein the ratio of the total length to the diameter of the screw is from about 15 to about 50.

3. The method of claim 1, wherein the screw has a first blending length that is defined from the point at which the fibrous filler is supplied to the extruder to the end of the screw, wherein the ratio of the first blending length to the diameter of the screw is from about 4 to about 20.

4. The method of claim 3, wherein the screw has a second blending length that is defined from the point at which the flow aid is supplied to the extruder to the end of the screw, wherein the ratio of the second blending length to the diameter of the screw is from about 5 to about 25.

5. The method of claim 1, wherein the aromatic amide oligomer has the following general formula (I): 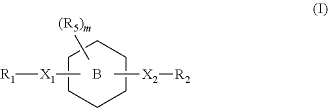
wherein,
ring B is a 6-membered aromatic ring wherein 1 to 3 ring carbon atoms are optionally replaced by nitrogen or oxygen, wherein each nitrogen is optionally oxidized, and wherein ring B may be optionally fused or linked to a 5- or 6-membered aryl, heteroaryl, cycloalkyl, or heterocyclyl;
R₅ is halo, haloalkyl, alkyl, alkenyl, aryl, heteroaryl, cycloalkyl, or heterocyclyl;
m is from 0 to 4;
X₁ and X₂ are independently C(O)HN or NHC(O);
R₁ and R₂ are independently selected from aryl, heteroaryl, cycloalkyl, and heterocyclyl.

6. The method of claim 5, wherein ring B is phenyl.

7. The method of claim 1, wherein the oligomer is selected from the group consisting of the following compounds and combinations thereof:

| Structure | Name |
|---|---|
| 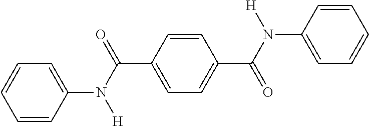 [SMILES: O=C(Nc1ccccc1)c1ccc(C(=O)Nc2ccccc2)cc1] | N1,N4- diphenylterephthalamide |
| 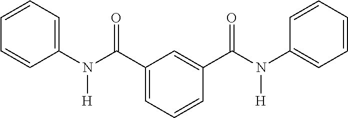 [SMILES: O=C(Nc1ccccc1)c1cccc(C(=O)Nc2ccccc2)c1] | N1,N4- diphenylisoterephthalamide |
| 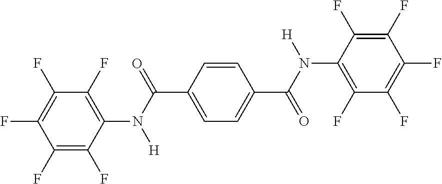 [SMILES: O=C(Nc1c(F)c(F)c(F)c(F)c1F)c1ccc(C(=O)Nc2c(F)c(F)c(F)c(F)c2F)cc1] | N1,N4-bis(2,3,4,5,6- pentafluorophenyl) terephthalamide |
| 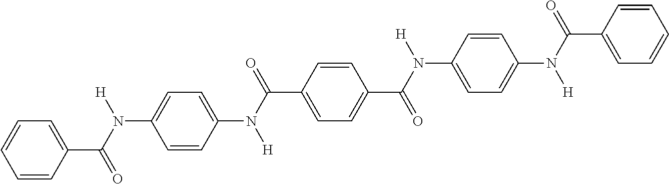 [SMILES: O=C(Nc1ccc(NC(=O)c2ccc(C(=O)Nc3ccc(NC(=O)c4ccccc4)cc3)cc2)cc1)c1ccccc1] | N1,N4-bis(4- benzamidophenyl) terephthalamide |
| 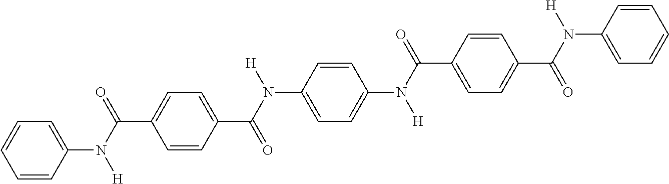 [SMILES: O=C(Nc1ccccc1)c1ccc(C(=O)Nc2ccc(NC(=O)c3ccc(C(=O)Nc4ccccc4)cc3)cc2)cc1] | N4-phenyl-N1-[4-[[4- (phenylcarbamoyl)benzoyl] amino]phenyl] terephthalamide |
| 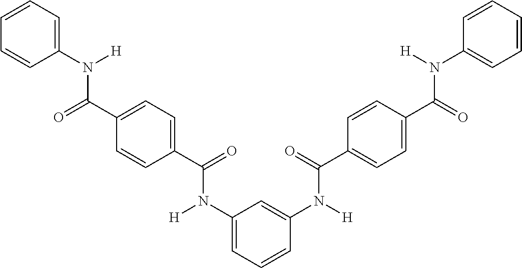 [SMILES: O=C(Nc1ccccc1)c1ccc(C(=O)Nc2cccc(NC(=O)c3ccc(C(=O)Nc4ccccc4)cc3)c2)cc1] | N4-phenyl-N1-[3-[[4- (phenylcarbamoyl)benzoyl] amino]phenyl] terephthalamide |
| 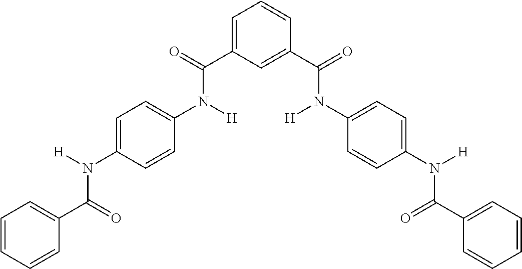 [SMILES: O=C(Nc1ccc(NC(=O)c2cccc(C(=O)Nc3ccc(NC(=O)c4ccccc4)cc3)c2)cc1)c1ccccc1] | N1,N3-bis(4- benzamidophenyl)benzene- 1,3-dicarboxamide |
| 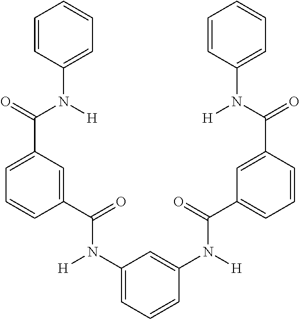 [SMILES: O=C(Nc1ccccc1)c1cccc(C(=O)Nc2cccc(NC(=O)c3cccc(C(=O)Nc4ccccc4)c3)c2)c1] | N3-phenyl-N1-[3-[[3- (phenylcarbamoyl)benzoyl] amino]phenyl]benzene- 1,3-dicarboxamide |
| 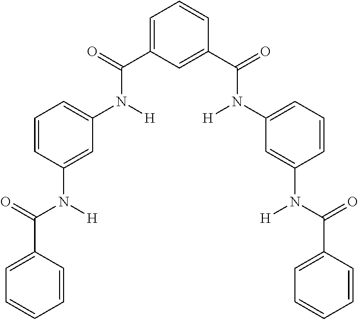 [SMILES: O=C(Nc1cccc(NC(=O)c2cccc(C(=O)Nc3cccc(NC(=O)c4ccccc4)c3)c2)c1)c1ccccc1] | N1,N3-bis(3- benzamidophenyl)benzene- 1,3-dicarboxamide |
| 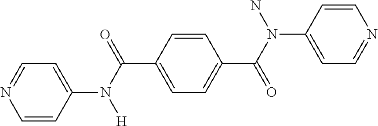 [SMILES: NN(C(=O)c1ccc(C(=O)Nc2ccncc2)cc1)c1ccncc1] | N1,N4-bis(4- pyridyl)terephthalamide |
| 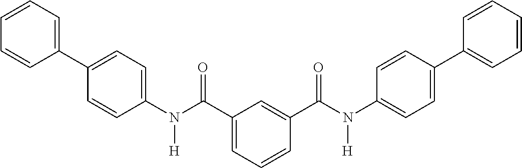 [SMILES: O=C(Nc1ccc(-c2ccccc2)cc1)c1cccc(C(=O)Nc2ccc(-c3ccccc3)cc2)c1] | N1,N3-bis(4- phenylphenyl)benzene- 1,3-dicarboxamide |
| 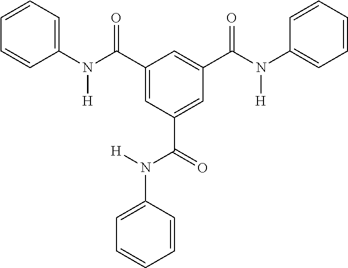 [SMILES: O=C(Nc1ccccc1)c1cc(C(=O)Nc2ccccc2)cc(C(=O)Nc2ccccc2)c1] | N1,N3,N5- triphenylbenzene-1,3,5- tricarboxamide |
| 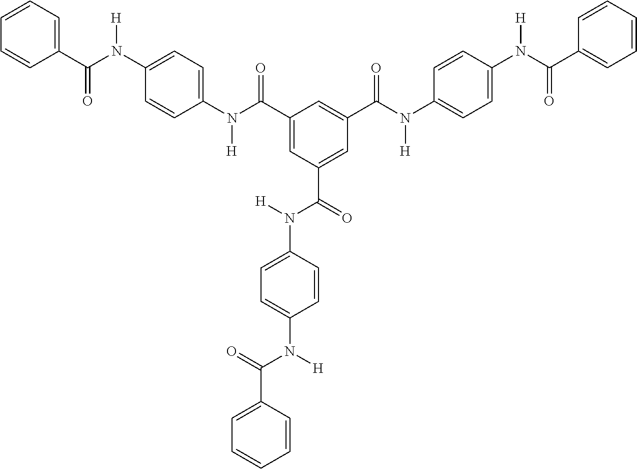 [SMILES: O=C(Nc1ccc(NC(=O)c2cc(C(=O)Nc3ccc(NC(=O)c4ccccc4)cc3)cc(C(=O)Nc3ccc(NC(=O)c4ccccc4)cc3)c2)cc1)c1ccccc1] | N1,N3,N5-tris(4- benzamidophenyl) benzene-1,3,5- tricarboxamide |
| 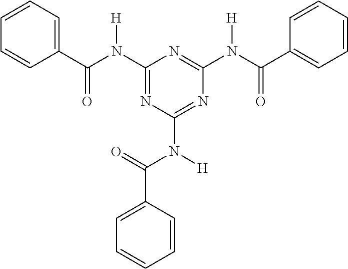 [SMILES: O=C(Nc1nc(NC(=O)c2ccccc2)nc(NC(=O)c2ccccc2)n1)c1ccccc1] | N-(4,6-dibenzamido-1,3,5- triazin-2-yl)benzamide |
| 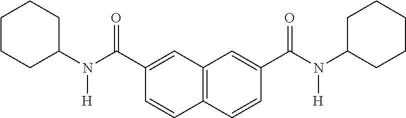 [SMILES: O=C(NC1CCCCC1)c1ccc2ccc(C(=O)NC3CCCCC3)cc2c1] | N2,N7- dicyclohexylnaphthalene- 2,7-dicarboxamide |
| 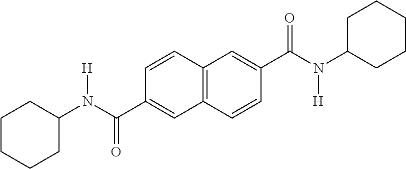 [SMILES: O=C(NC1CCCCC1)c1ccc2cc(C(=O)NC3CCCCC3)ccc2c1] | N2,N6- dicyclohexylnaphthalene- 2,6-dicarboxamide |
| 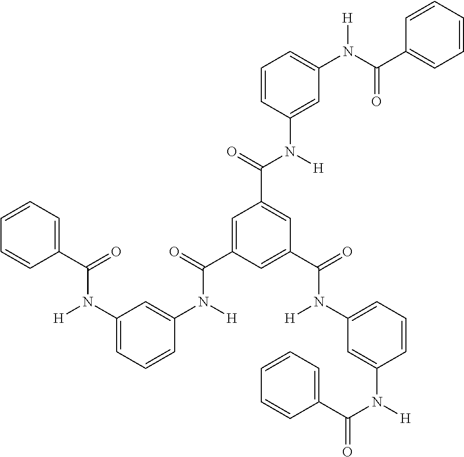 [SMILES: O=C(Nc1cccc(NC(=O)c2cc(C(=O)Nc3cccc(NC(=O)c4ccccc4)c3)cc(C(=O)Nc3cccc(NC(=O)c4ccccc4)c3)c2)c1)c1ccccc1] | N1,N3,N5-tris(3- benzamidophenyl) benzene-1,3,5- tricarboxamide |
| 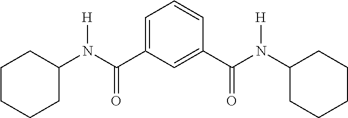 [SMILES: O=C(NC1CCCCC1)c1cccc(C(=O)NC2CCCCC2)c1] | 1,3- Benzenedicarboxamide, N1,N3-dicyclohexyl |

8. The method of claim 1, wherein the oligomer has a molecular weight of about 3,000 grams per mole or less.

9. The method of claim 1, wherein the liquid crystalline polymer is wholly aromatic.

10. The method of claim 1, wherein the liquid crystalline polymer contains monomer repeat units derived from one or more aromatic hydroxycarboxylic acids, aromatic dicarboxylic acids, aromatic diols, aromatic amines, aromatic diamines, or a combination of the foregoing.

11. The method of claim 1, wherein the liquid crystalline polymer contains monomer repeat units derived from 4-hydroxybenzoic acid, 6-hydroxy-2-naphthoic acid, terephthalic acid, isophthalic acid, 4,4′-biphenol, hydroquinone, acetaminophen, or a combination of the foregoing.

12. The method of claim 1, wherein the fibrous filler includes glass fibers.

13. The method of claim 1, wherein the polymer composition has a melt viscosity of from about 0.5 to about 80 Pa-s, determined in accordance with ISO Test No. 11443 at a temperature of 350° C. and at a shear rate of 1000 s⁻¹.

14. A polymer composition comprising the method of claim 1.

15. A molded part comprising the polymer composition of claim 14.

16. The molded part of claim 15, wherein the part exhibits a blister free temperature of about 250° C. or greater.

17. The molded part of claim 15, wherein the part contains opposing walls having a width of about 500 micrometers or less.

18. The molded part of claim 15, wherein the part is a planar substrate having a thickness of about 500 micrometers or less.

19. An electronic component that comprises the molded part of claim 15, wherein the electronic component is a cellular telephone, laptop computer, small portable computer, wrist-watch device, pendant device, headphone or earpiece device, media player with wireless communications capabilities, handheld computer, remote controller, global positioning system, handheld gaming device, battery cover, speaker, integrated circuit, electrical connector, camera module, or a combination thereof.

20. A molded part comprising a polymer composition, wherein the polymer composition has a melt viscosity of from about 0.5 to about 80 Pa-s, determined in accordance with ISO Test No. 11443 at a temperature of 350° C. and at a shear rate of 1000 s⁻¹, the composition comprising from about 30 wt. % to about 95 wt. % of a thermotropic liquid crystalline polymer, from about 2 wt. % to about 40 wt. % of a fibrous filler, and from about 0.1 wt. % to about 10 wt. % of an aromatic amide oligomer, wherein the molded part has a blister free temperature of about 250° C. or more.

21. The molded part of claim 20, wherein the aromatic amide oligomer has the following general formula (I): 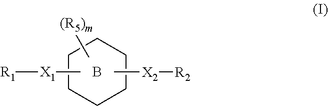
wherein,
ring B is a 6-membered aromatic ring wherein 1 to 3 ring carbon atoms are optionally replaced by nitrogen or oxygen, wherein each nitrogen is optionally oxidized, and wherein ring B may be optionally fused or linked to a 5- or 6-membered aryl, heteroaryl, cycloalkyl, or heterocyclyl;
R₅ is halo, haloalkyl, alkyl, alkenyl, aryl, heteroaryl, cycloalkyl, or heterocyclyl;
m is from 0 to 4;
X₁ and X₂ are independently C(O)HN or NHC(O);
R₁ and R₂ are independently selected from aryl, heteroaryl, cycloalkyl, and heterocyclyl.

22. The molded part of claim 21, wherein ring B is phenyl.

23. The molded part of claim 20, wherein the oligomer is selected from the group consisting of the following compounds and combinations thereof:

| Structure | Name |
|---|---|
| 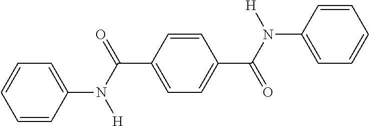 [SMILES: O=C(Nc1ccccc1)c1ccc(C(=O)Nc2ccccc2)cc1] | N1,N4- diphenylterephthalamide |
| 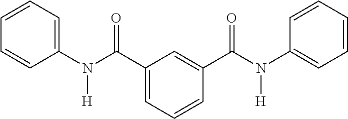 [SMILES: O=C(Nc1ccccc1)c1cccc(C(=O)Nc2ccccc2)c1] | N1,N4- diphenylisoterephthalamide |
| 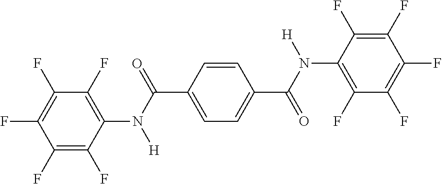 [SMILES: O=C(Nc1c(F)c(F)c(F)c(F)c1F)c1ccc(C(=O)Nc2c(F)c(F)c(F)c(F)c2F)cc1] | N1,N4-bis(2,3,4,5,6- pentafluorophenyl) terephthalamide |
| 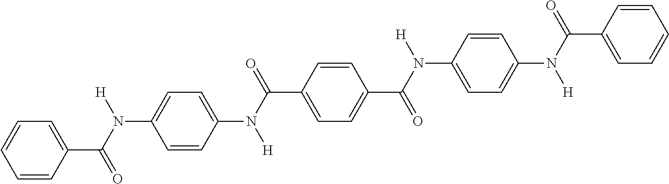 [SMILES: O=C(Nc1ccc(NC(=O)c2ccc(C(=O)Nc3ccc(NC(=O)c4ccccc4)cc3)cc2)cc1)c1ccccc1] | N1,N4-bis(4- benzemidophenyl) terephthalamide |
| 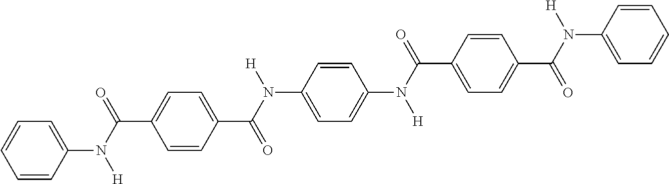 [SMILES: O=C(Nc1ccccc1)c1ccc(C(=O)Nc2ccc(NC(=O)c3ccc(C(=O)Nc4ccccc4)cc3)cc2)cc1] | N4-phenyl-N1[4-[[4- (phenylcarbamoyl)benzoyl] amino]phenyl] terephthalamide |
| 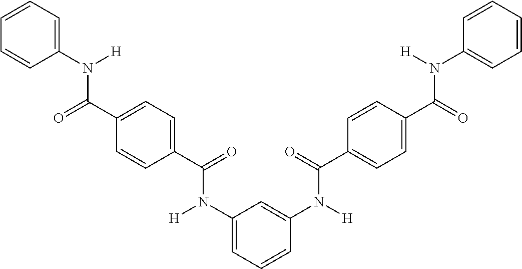 [SMILES: O=C(Nc1ccccc1)c1ccc(C(=O)Nc2cccc(NC(=O)c3ccc(C(=O)Nc4ccccc4)cc3)c2)cc1] | N4-phenyl-N1-[3-[[4- (phenylcarbamoyl)benzoyl] amino]phenyl] terephthalamide |
| 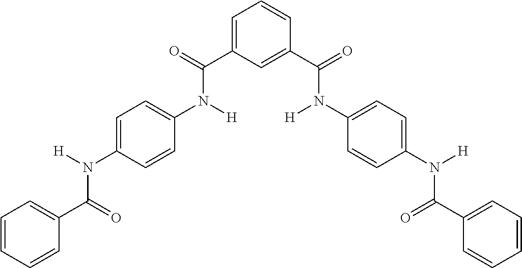 [SMILES: O=C(Nc1ccc(NC(=O)c2cccc(C(=O)Nc3ccc(NC(=O)c4ccccc4)cc3)c2)cc1)c1ccccc1] | N1,N3-bis(4- benzamidophenyl)benzene- 1,3-dicarboxamide |
| 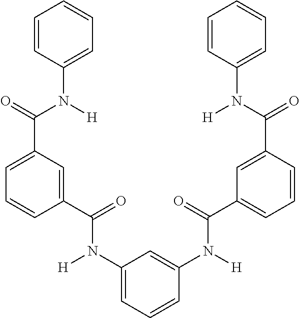 [SMILES: O=C(Nc1ccccc1)c1cccc(C(=O)Nc2cccc(NC(=O)c3cccc(C(=O)Nc4ccccc4)c3)c2)c1] | N3-phenyl-N1-[3-[[3- (phenylcarbamoyl)benzoyl] amino]phenyl]benzene- 1,3-dicarboxamide |
| 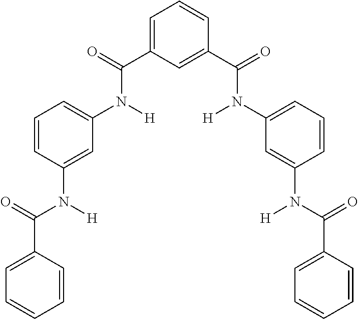 [SMILES: O=C(Nc1cccc(NC(=O)c2cccc(C(=O)Nc3cccc(NC(=O)c4ccccc4)c3)c2)c1)c1ccccc1] | N1,N3-bis(3- benzamidophenyl)benzene- 1,3-dicarboxamide |
| 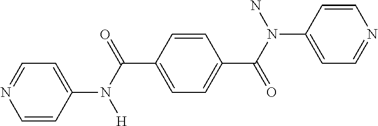 [SMILES: NN(C(=O)c1ccc(C(=O)Nc2ccncc2)cc1)c1ccncc1] | N1,N4-bis(4- pyridyl)terephthalamide |
| 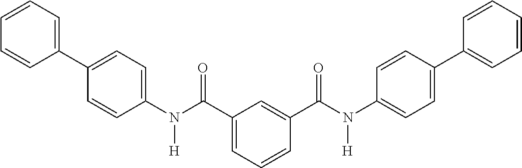 [SMILES: O=C(Nc1ccc(-c2ccccc2)cc1)c1cccc(C(=O)Nc2ccc(-c3ccccc3)cc2)c1] | N1,N3-bis(4- phenylphenyl)benzene- 1,3-dicarboxamide |
| 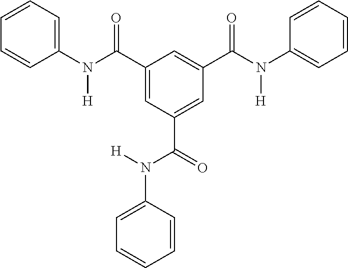 [SMILES: O=C(Nc1ccccc1)c1cc(C(=O)Nc2ccccc2)cc(C(=O)Nc2ccccc2)c1] | N1,N3,N5- triphenylbenzene-1,3,5- tricarboxamide |
| 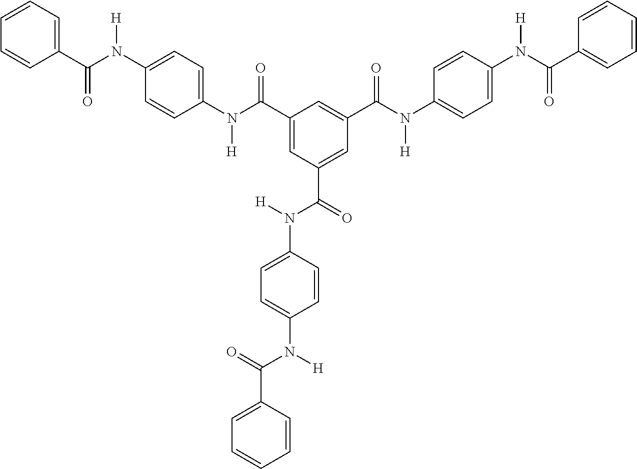 [SMILES: O=C(Nc1ccc(NC(=O)c2cc(C(=O)Nc3ccc(NC(=O)c4ccccc4)cc3)cc(C(=O)Nc3ccc(NC(=O)c4ccccc4)cc3)c2)cc1)c1ccccc1] | N1,N3,N5-bis(4- benzamidophenyl)benzene- 1,3,5-tricarboxamide |
| 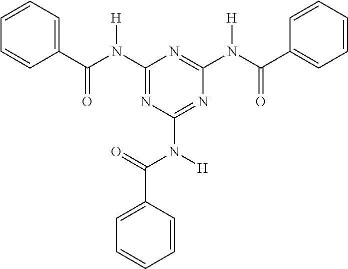 [SMILES: O=C(Nc1nc(NC(=O)c2ccccc2)nc(NC(=O)c2ccccc2)n1)c1ccccc1] | N-(4,6-dibenzamido- 1,3,5-triazin-2- yl)benzamide |
| 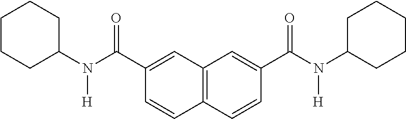 [SMILES: O=C(NC1CCCCC1)c1ccc2ccc(C(=O)NC3CCCCC3)cc2c1] | N2,N7- dicyclohexylnaphthalene- 2,7-dicarboxamide |
| 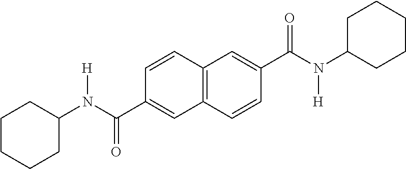 [SMILES: O=C(NC1CCCCC1)c1ccc2cc(C(=O)NC3CCCCC3)ccc2c1] | N2,N6- dicyclohexylnaphthalene- 2,6-dicarboxamide |
| 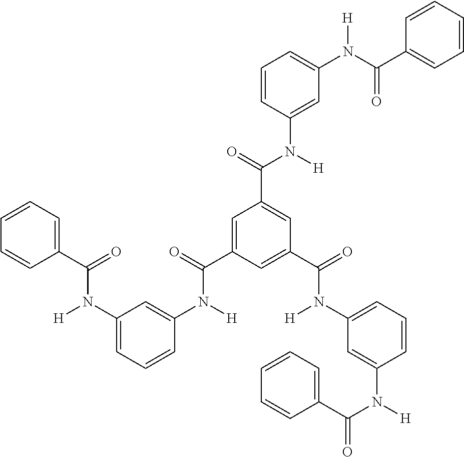 [SMILES: O=C(Nc1cccc(NC(=O)c2cc(C(=O)Nc3cccc(NC(=O)c4ccccc4)c3)cc(C(=O)Nc3cccc(NC(=O)c4ccccc4)c3)c2)c1)c1ccccc1] | N1,N3,N5-tris(3- benzamidophenyl)benzene- 1,3,5-tricarboxamide |
| 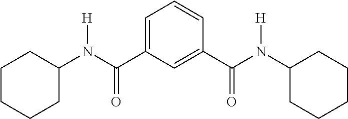 [SMILES: O=C(NC1CCCCC1)c1cccc(C(=O)NC2CCCCC2)c1] | 1,3- Benzenedicarboxamide, N1,N3-dicyclohexyl- |
| 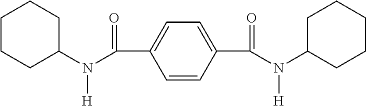 [SMILES: O=C(NC1CCCCC1)c1ccc(C(=O)NC2CCCCC2)cc1] | 1,4- Benzenedicarboxamide, N1,N3-dicyclohexyl- |

24. The molded part of claim 20, wherein the oligomer has a molecular weight of about 3,000 grams per mole or less.

25. The molded part of claim 20, wherein the liquid crystalline polymer is wholly aromatic.

26. The molded part of claim 20, wherein the liquid crystalline polymer contains monomer repeat units derived from one or more aromatic hydroxycarboxylic acids, aromatic dicarboxylic acids, aromatic diols, aromatic amines, aromatic diamines, or a combination of the foregoing.

27. The molded part of claim 20, wherein the liquid crystalline polymer contains monomer repeat units derived from 4-hydroxybenzoic acid, 6-hydroxy-2-naphthoic acid, terephthalic acid, isophthalic acid, 4,4′-biphenol, hydroquinone, acetaminophen, or a combination of the foregoing.

28. The molded part of claim 20, wherein the fibrous filler includes glass fibers.
